(19) United States
(12) Patent Application Publication
(10) Pub. No.: US 2016/0324169 A1
(43) Pub. Date: Nov. 10, 2016

(54) Pasteurized Shell Eggs with Improved Albumen Quality

(71) Applicant: National Pasteurized Eggs, Inc., Lansing, IL (US)

(72) Inventors: Hector Gregorio Lara, Plainfield, IL (US); Praveena Munukuru, Plainfield, IL (US)

(73) Assignee: National Pasteurized Eggs, Inc., Lansing, IL (US)

(21) Appl. No.: 15/140,561

(22) Filed: Apr. 28, 2016

Related U.S. Application Data
(60) Provisional application No. 62/157,139, filed on May 5, 2015.

(51) Int. Cl. A23B 5/005; A23B 5/06; A23B 5/01

(52) U.S. Cl. CPC A23B 5/0052; A23B 5/01; A23B 5/06; A23L 1/32; A23V 2002/00

(57) ABSTRACT

Chicken shell eggs pasteurized in a water bath set at a temperature of no more that substantially about 133° F. (±0.5° F.) result in eggs having measured albumen turbidity normally less than 200 Nephelometric Turbidity Units.

### FIELD OF THE INVENTION

The invention relates to pasteurized shell eggs with improved albumen quality. In particular, the invention pertains to the discovery that pasteurizing shell eggs in a water bath having a temperature of 133° F. (+/−0.5° F.) or less results in significantly improved albumen quality, namely measured albumen turbidity reliably below 200 NTU (Nephelometeric Turbidity Unit).

### BACKGROUND OF THE INVENTION

The Assignee of the present application owns several patents pertaining to the pasteurization of shell eggs including, for example, U.S. Pat. No. 6,165,538 entitled “Pasteurized In-Shell Chicken Eggs”, by Leon John Davidson, issuing on Dec. 26, 2000; U.S. Pat. No. 6,113,961 entitled “Apparatus and Methods for Pasteurizing in-Shell Eggs,” by Louis Polster, and U.S. Pat. No. 9,289,002, entitled “Shell Egg Pasteurization Method” issued on Mar. 22, 2016, by Hector Lara, each of which is incorporated herein by reference. Current commercial pasteurization processes heat batches of shell eggs in heated water and/or humid air. In the process discussed in the Lara '002 patent, batches of shell eggs are submerged in a heated water bath and are moved sequentially from zone to zone in order to complete the pasteurization process. The present invention relates to the thermal treatment necessary for sufficient pasteurization. While other pasteurization systems may not move the batches of eggs sequentially through zones in a water bath, certain aspects of the present invention may apply to those other systems as well.

The purpose of the pasteurization process is to heat the shell egg such that the entire egg including the center of the egg yolk warms to an adequate temperature for a sufficient amount of time to meet or exceed the accepted standard for reduction of Salmonella Enteritidis set by the FDA. A 5 log reduction of Salmonella Enteritidis is the regulated standard set by the FDA (Food and Drug Administration) and WHO (World Health Organization) for an in-shell chicken egg to be labeled as pasteurized.

It is critical that sufficient heat be provided to meet the 5 log kill standard throughout the entire mass of the egg; however, it is also important the egg not be overheated during the pasteurization process. Overheating can result in partial cooking or loss of quality and functionality of the shell egg. There are many characteristics pertaining to egg quality and functionality, see for instance the characteristics measured and observed in above incorporated Davidson U.S. Pat. No. 6,165,538. One of the most common functionality tests is to measure albumen quality in Haugh units. As an unpasteurized egg ages, the thick inner portion of the albumen tends to thin. Haugh units are calculated using both the egg weight and the height of the inner thick albumen of an egg cracked open on a flat surface. Standard Haugh unit values for different grades of eggs are follows: Grade AA is greater than 72 Haugh units, Grade A is between 60 and 72 Haugh units, and Grade B is less than 60 Haugh units. The USDA (United States Department of Agriculture) requires that all eggs for human consumption be graded both in terms of weight (minimum weight requirements for applicable size e.g.: Medium, Large and Extra-Large) and quality as measured in Haugh units (Grade AA, Grade A, Grade B). It is know in the art, however, that pasteurization leads to higher Haugh unit values compared to a corresponding unpasteurized egg. During the pasteurization process, thermal energy causes the albumen to denature and then cross link, which results in a higher tighter inner albumen and higher Haugh unit values. As more heat is added, the albumen becomes cloudy and eventually begins to coagulate as well. The Davidson '538 patent recognizes that increased Haugh unit values and cloudy egg whites occur with pasteurization. It is also recognized in the art that the time to whip albumen to peak height increases about 8-fold when an egg is pasteurized using current thermal techniques.

Prior to the present invention, it was generally believed that the shell eggs should be held in the water bath for the minimum amount of time (or near the minimum amount of time) necessary to reliably achieve a 5 log kill of Salmonella Enteritidis throughout the egg. It was believed that keeping the amount of time near the minimum amount of time would result in less cloudiness in the albumen and affect whipping time less than holding the shells eggs in the water long enough to achieve for example a 7 log kill of Salmonella Enteritidis throughout the egg.

In prior art batch processing pasteurization equipment using a heated water bath, each batch contains many dozens of eggs typically arranged in flats and stacked one upon another, for example, as described in the incorporated Polster '961 patent and the Lara '002 patent. Prior to pasteurization, the stacks of eggs are staged and held at a uniform start temperature. For example, refrigerated stacks of eggs may be held at 45° F. for storage and then moved to and placed into the pasteurization bath with an egg start temperature of 45° F. Alternatively, refrigerated or unrefrigerated eggs may be tempered to room temperature, e.g. 65° F., prior to being moved to and placed in the pasteurization bath. The batch processing control system is programmed with pasteurization protocols that typically vary water bath temperature and overall dwell time depending on the egg size (e.g. medium size versus large size) and start temperature for the batch. Significant efforts have been made in the art to reliably heat pasteurized shell eggs to consistently achieve the required, accumulated 5 log kill without overcooking the eggs, see e.g. Schuman et al., “Immersion heat treatments for inactivation of Salmonella enteritidis with in tact eggs,” Journal of Applied Microbiology 1997, 83, 438-444, and the incorporated Davidson '538 patent.

A D-value (measured in minutes) is the amount of time that it takes to achieve a log kill of a pathogen (e.g. Salmonella Enteritidis) in a substance held at a certain temperature. D-values for Salmonella Enteritidis are known to be higher in egg yolk than in albumen, which means that it is more difficult to kill Salmonella Enteritidis in egg yolk than in albumen. The Davidson '538 patent is based in part on the notion that heating a shell egg in a water bath requires heat to transfer through the shell and through the albumen to the yolk, so the temperature of the albumen will necessarily be greater than the temperature of the yolk when the egg is coming up to the temperature of the water bath. According to FDA requirements and the Davidson '538 patent, the yolk temperature must be at least 128° F. before Salmonella Enteritidis is killed reliably. The Davidson '538 patent therefore provides a statistically derived line plotting a 5 D-value (i.e., five times the D-value) for shell eggs inoculated with Salmonella Enteritidis having yolk temperatures from 128° F. to 138° F. As the egg yolk heats from 128° F. to the water bath temperature, the log kill accumulates and it continues to accumulate as the yolk is maintained at or near the water bath temperature. In fact, log kill continues to accumulate even after the shell egg is removed from the pasteurization bath until the yolk drops to 128° F. The examples in the Davidson '538 patent use an initial bath water temperature of 138° F., and then cool the bath to 133° F. or 134° F. to complete the pasteurization process. Davidson noted that the albumen of eggs pasteurized in this manner were cloudy. He also indicated, as mentioned above that it would take significantly longer to whip the albumen to peak height than with albumen from a corresponding unpasteurized egg.

In the system described in the Lara '002 patent, each batch of eggs is held in a carrier that is supported by a gantry located above the water bath and is moved in stages through each of the zones in the water bath. An advance motor moves the respective carriers sequentially from stage to stage and zone to zone at fixed time intervals. A heating system heats the water bath to a thermostatic set point in accordance with the pasteurization protocol selected for the size and start temperature of the batches being pasteurized. Pressurized air is supplied through openings into the water bath to cause perturbation and facilitate effective, uniform heat transfer throughout the stacks of shell eggs. The level of the air flow can also be set in the pasteurization protocols as disclosed in the Lara '002 patent. Since there is a risk of temperature spikes occurring in the pasteurization bath that can cause overcooking and poor quality pasteurized eggs, the system in the Lara '002 patent provides a cooling system for the pasteurization bath. The pasteurization protocol as taught in the Lara '002 patent is programmed with an upper temperature limit that is higher than the temperature set point for the heating system. The cooling system operates to lower the temperature of the water bath as the temperature in the bath approaches the upper temperature limit and in turn mitigates any temperature spikes. The use of a cooling system in this manner enables the pasteurization system to aggressively maintain the water bath temperature at or near the minimum required temperature for the approved FDA time and temperature protocol.

After removal from the pasteurization bath, the eggs are sprayed with an antibacterial agent, and coated with food-grade wax or other sealant to protect the eggs from outside contaminants and improve shelf life. Despite the close attention and effort to not overcook and otherwise maintain high quality and functionality standards, those in the art are continually searching for ways to improve the quality and functionality of pasteurized in-shell chicken eggs. For example, pasteurization in a 134° F. water bath for the time necessary to achieve a 5 log reduction of Salmonella Enteritidis using the model set forth in the Davidson '538 patent results in slight but noticeable cloudiness. Pasteurizing in a 133.5° F. water bath has been tried commercially with little success for reducing albumen cloudiness. Pasteurization in a 133.5° F. water bath requires more time to achieve a 5 log reduction of Salmonella Enteritidis in the yolk than pasteurizing in 134° F. water bath. At the increased dwell time necessary for pasteurization at 133.5° F., there is no noticeable difference in the albumen cloudiness compared to using a 134° F. water bath. However, the production throughput due to the increase dwell time for using a water bath set at 133.5° F. is less than the production throughput using a 134° F. water bath.

### SUMMARY OF THE INVENTION

The inventors have discovered that holding chicken shell eggs in a a heated fluid pasteurization medium (e.g. a heated water bath) at substantially about 133° F. (i.e., ±0.5° F.) or less for a long enough time to achieve a 5 log reduction of Salmonella Enteritidis throughout the egg results in the pasteurized shell egg having an albumen with significantly less cloudiness than prior art pasteurized shell eggs. Surprisingly, holding the chicken shell eggs in a water bath at substantially about 134° F. (i.e., ±0.5° F.) for a long enough time to achieve a 5 log reduction of Salmonella Enteritidis throughout the egg results in the pasteurized shell egg having an albumen with significantly more cloudiness than holding the chicken shell eggs in a water bath at 133° F. (±0.5° F.) for a long enough time to achieve a 5 log reduction of Salmonella Enteritidis throughout the egg. Data collected by the inventors indicates that albumen turbidity normally remains less than 200 NTU for room temperature, large shell eggs held in a water bath at 133° F. (±0.5° F.) for at least 62 minutes, which is longer than the amount of time needed to achieve a 5-log reduction of Salmonella Enteritidis throughout the egg in the Davidson '538 patent. Previously, these levels of turbidity were thought to be unobtainable in a chicken shell egg pasteurized sufficiently to achieve a 5 log kill of Salmonella Enteritidis. On the other hand, the data collected by the inventors indicates that albumen turbidity is about 250 NTU for room temperature, large shell eggs in a water bath at 134° F. (±0.5° F.) for 50 or 52 minutes, which is the amount of time needed to achieve a 5 log reduction of Salmonella Enteritidis throughout the egg using the model set forth in the Davidson '538 patent.

In one embodiment, a shell egg pasteurization system implementing the invention includes a pasteurization water bath having a series of at least two continuous zones. There are one or more temperature sensors in each zone of the bath for measuring the water temperature in the zone of the bath. A heating system operates to heat the temperature of the water in each zone of the bath to a temperature set point value of no higher than substantially about 133° F. (+/−0.5° F.). The heating system includes at least one independently controlled heating element in each zone of the bath to achieve uniform heating throughout the bath. A batch carrier arrangement holds batches of shell eggs in the bath and includes an advance motor that moves the batch carrier arrangement and the respective batches of shell eggs through and between zones. The system also includes a batch processing control system that is programmed with at least one pasteurization protocol. The protocol sets the temperature set point value for the water bath at about 133° F. (±0.5° F.), and sets the total dwell time for each batch in the bath to a predetermined time, as mentioned to ensure that both the yolk and albumen of the eggs are pasteurized to achieve a 5 log reduction of Salmonella enteritidis that may be present in the yolk and albumen of the eggs prior to pasteurization. The term substantially about in this patent means±0.5° F. A dwell time of up to 62 minutes for large shell eggs in a water bath at substantially about 133° F. (±0.5° F.) does not normally cause albumen turbidity exceeding 200 nephelometeric turbidity units.

It is desirable that the batches of eggs be pasteurized in stacks of eggs on flats. It is further desirable that pressurized air flow into the water bath to facilitate even heating of all the eggs in the stack.

While the heated fluid pasteurization medium takes the form of a heated water bath in the exemplary embodiment of the invention in connection with the drawings, the heated fluid pasteurization medium can take other forms, such as heated humid air, or convection of heated air, or a combination of these heating techniques or others. The fundamental discovery of the inventors being that processing the shell eggs a temperature of no higher than substantially 133° F. (±0.5° F.) produces a pasteurized egg with significantly less cloudiness in the albumen.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic drawing illustrating the movement of batches of eggs through multiple zones in an exemplary shell egg pasteurization system.

FIG. 2 is a view taken along line 2-2 in FIG. 1.

FIG. 3 schematically illustrates a time and temperature control system constructed in accordance with the invention for use in the exemplary shell egg pasteurization system of FIG. 1.

FIG. 4 is a schematic illustration of a PID algorithm used to individually control a heating element in accordance with the preferred embodiment of the invention.

FIG. 5a is a color photograph of the break out appearance of shell eggs pasteurized in a 133° F. water bath for 42 minutes on a black plate.

FIG. 5b is a color photograph of the break out appearance of a shell eggs pasteurized in a 133° F. water bath for 43 minutes on a black plate.

FIG. 5c is a color photograph of the break out appearance of shell eggs pasteurized in a 133° F. water bath for 44 minutes on a black plate.

FIG. 5d is a color photograph of the break out appearance of shell eggs pasteurized in a 133° F. water bath for 45 minutes on a black plate.

FIG. 5e is a color photograph of the break out appearance of shell eggs pasteurized in a 133° F. water bath for 46 minutes on a black plate.

FIG. 5f is a color photograph of the break out appearance of shell eggs pasteurized in a 133° F. water bath for 47 minutes on a black plate.

FIG. 5g is a color photograph of the break out appearance of shell eggs pasteurized in a 133° F. water bath for 48 minutes on a black plate.

FIG. 5h is a color photograph of the break out appearance of shell eggs pasteurized in a 133° F. water bath for 49 minutes on a black plate.

FIG. 5i is a color photograph of the break out appearance of shell eggs pasteurized in a 133° F. water bath for 50 minutes on a black plate.

FIG. 5j is a color photograph of the break out appearance of shell eggs pasteurized in a 133° F. water bath for 51 minutes on a black plate.

FIG. 5k is a color photograph of the break out appearance of shell eggs pasteurized in a 133° F. water bath for 52 minutes on a black plate.

FIG. 5l is a color photograph of the break out appearance of shell eggs pasteurized in a 133° F. water bath for 53 minutes on a black plate.

FIG. 5m is a color photograph of the break out appearance of shell eggs pasteurized in a 133° F. water bath for 54 minutes on a black plate.

FIG. 5n is a color photograph of the break out appearance of shell eggs pasteurized in a 133° F. water bath for 55 minutes on a black plate.

FIG. 5o is a color photograph of the break out appearance of shell eggs pasteurized in a 133° F. water bath for 56 minutes on a black plate.

FIG. 5p is a color photograph of the break out appearance of shell eggs pasteurized in a 133° F. water bath for 57 minutes on a black plate.

FIG. 5q is a color photograph of the break out appearance of shell eggs pasteurized in a 133° F. water bath for 58 minutes on a black plate.

FIG. 5r is a color photograph of the break out appearance of shell eggs pasteurized in a 133° F. water bath for 59 minutes on a black plate.

FIG. 5s is a color photograph of the break out appearance of shell eggs pasteurized in a 133° F. water bath for 60 minutes on a black plate.

FIG. 5t is a color photograph of the break out appearance of shell eggs pasteurized in a 133° F. water bath for 61 minutes on a black plate.

FIG. 5u is a color photograph of the break out appearance of shell eggs pasteurized in a 133° F. water bath for 62 minutes on a black plate.

FIG. 6a is a color photograph of the break out appearance of shell eggs pasteurized in a 133° F. water bath for 42 minutes on clear glass.

FIG. 6b is a color photograph of the break out appearance of a shell eggs pasteurized in a 133° F. water bath for 43 minutes on clear glass.

FIG. 6c is a color photograph of the break out appearance of shell eggs pasteurized in a 133° F. water bath for 44 minutes on clear glass.

FIG. 6d is a color photograph of the break out appearance of shell eggs pasteurized in a 133° F. water bath for 45 minutes on clear glass.

FIG. 6e is a color photograph of the break out appearance of shell eggs pasteurized in a 133° F. water bath for 46 minutes on clear glass.

FIG. 6f is a color photograph of the break out appearance of shell eggs pasteurized in a 133° F. water bath for 47 minutes on clear glass.

FIG. 6g is a color photograph of the break out appearance of shell eggs pasteurized in a 133° F. water bath for 48 minutes on clear glass.

FIG. 6h is a color photograph of the break out appearance of shell eggs pasteurized in a 133° F. water bath for 49 minutes on clear glass.

FIG. 6i is a color photograph of the break out appearance of shell eggs pasteurized in a 133° F. water bath for 50 minutes on clear glass.

FIG. 6j is a color photograph of the break out appearance of shell eggs pasteurized in a 133° F. water bath for 51 minutes on clear glass.

FIG. 6k is a color photograph of the break out appearance of shell eggs pasteurized in a 133° F. water bath for 52 minutes on clear glass.

FIG. 6l is a color photograph of the break out appearance of shell eggs pasteurized in a 133° F. water bath for 53 minutes on clear glass.

FIG. 6m is a color photograph of the break out appearance of shell eggs pasteurized in a 133° F. water bath for 54 minutes on clear glass.

FIG. 6n is a color photograph of the break out appearance of shell eggs pasteurized in a 133° F. water bath for 55 minutes on clear glass.

FIG. 6o is a color photograph of the break out appearance of shell eggs pasteurized in a 133° F. water bath for 56 minutes on clear glass.

FIG. 6p is a color photograph of the break out appearance of shell eggs pasteurized in a 133° F. water bath for 57 minutes on clear glass.

FIG. 6q is a color photograph of the break out appearance of shell eggs pasteurized in a 133° F. water bath for 58 minutes on clear glass.

FIG. 6r is a color photograph of the break out appearance of shell eggs pasteurized in a 133° F. water bath for 59 minutes on clear glass.

FIG. 6s is a color photograph of the break out appearance of shell eggs pasteurized in a 133° F. water bath for 60 minutes on clear glass.

FIG. 6t is a color photograph of the break out appearance of shell eggs pasteurized in a 133° F. water bath for 61 minutes on clear glass.

FIG. 6u is a color photograph of the break out appearance of shell eggs pasteurized in a 133° F. water bath for 62 minutes on clear glass.

FIG. 7 is a color photograph of the break out appearance of shell eggs pasteurized in a 134° F. water bath for 50 minutes on a black plate.

### DETAILED DESCRIPTION OF THE DRAWINGS

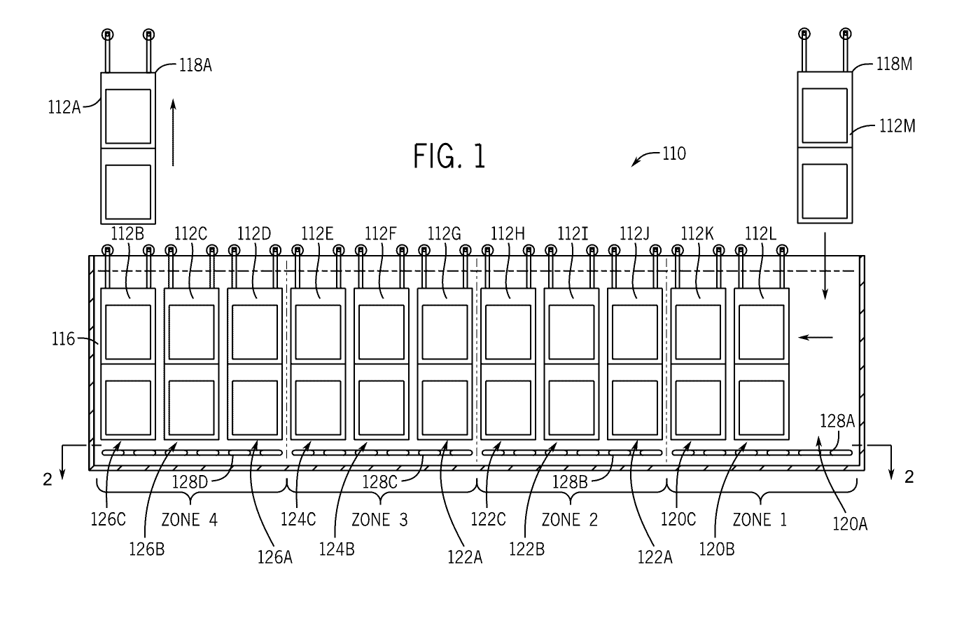

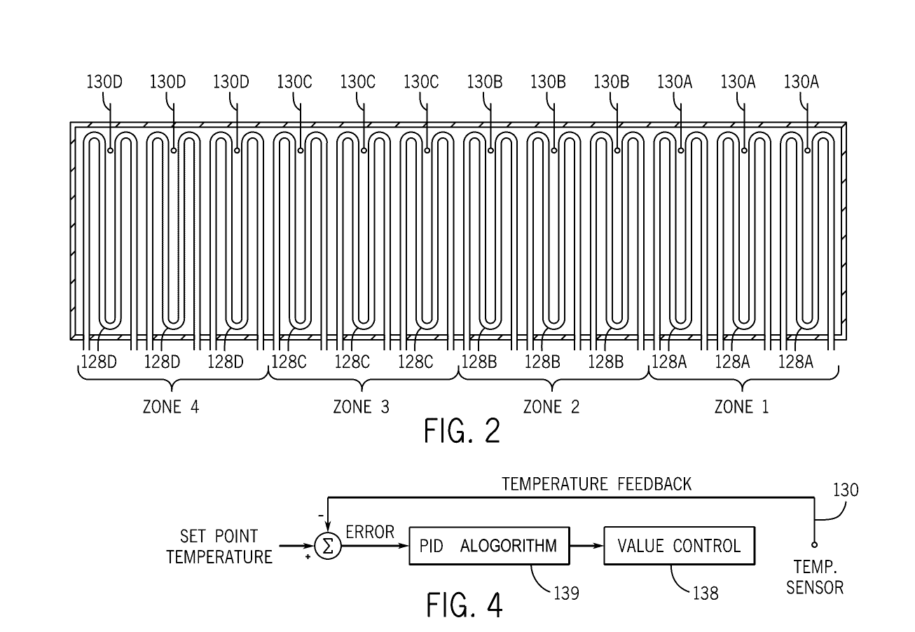

FIGS. 1 and 2 illustrate an exemplary shell egg pasteurization system 110 in which batches 112A through 112M of eggs are passed through four zones (Zones 1 through 4) of a heated pasteurization water bath 116. Details of the exemplary system 110 are described in the above incorporated Lara '002 patent. In commercial operations, it is not efficient or cost effective to pasteurize a single egg, a single row or even a single layer of shell eggs at a time. Therefore, it is known in the art to pasteurize batches of eggs containing several stacked layers of eggs. For example, a flat may contain 2½ dozen eggs, with a stack containing four layers of flats and each batch containing 16 stacks loaded onto a carrier 118A through 118M. Generally speaking, the bath 116 must heat not only the eggs, but also the flats and the carriers. Even though the carriers 118A-118M and the flats are typically the same whether the eggs being pasteurized are Medium size, Large, Ex-Large or Jumbo, the different size and weight of the eggs will normally impact the heat required in Zone 1 of the bath 116 differently.

As shown in FIG. 1, each zone in the pasteurization bath 116 includes a first, second and third staging position, 120A, 120B, and 120C for Zone 1, 122A, 122B, 122C for Zone 2, 124A, 124B, 124C for Zone 3 and 126A, 126B, 126C for Zone 4. There are therefore 12 staging positions within the bath 116 shown in the embodiment in FIG. 1. FIG. 1 also shows a carrier 118M containing batch 112M of eggs prior to being placed in the bath 116, and carrier 118A containing batch 112A of eggs which has been removed from the bath at 116 after pasteurization. Note that the carriers 118B through 118L containing batches of eggs 112B through 112L are located within the bath 116 and have been moved forward one stage in preparation for the bath 116 to receive carrier 118M and batch 112M in the first staging position 120A of Zone 1. The heated water in the bath 116 is allowed to flow between zones inasmuch as Zones 1, 2, 3 and 4 are physically continuous. It should be understood, however, that the schematic representation of the system 110 in FIG. 1 is merely representative of a type of pasteurization system in which the invention may be used, and that the invention may be useful with other types of pasteurization systems.

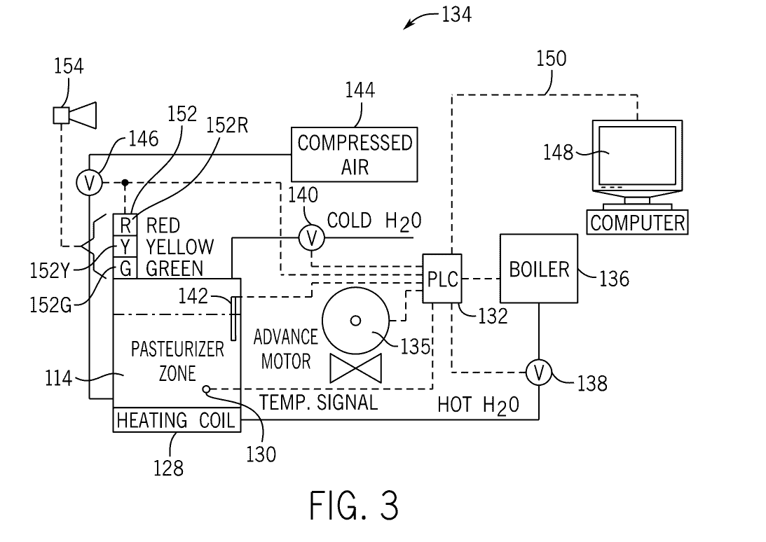

Referring still to FIGS. 1 and 2, sets of heating coils 128A through 128D are located in each respective zone to heat the fluid within the zone. In accordance with the exemplary embodiment of the invention, each of the heating coils in each set of heating coils 128A through 128D are controlled independently. Temperature sensors 130A, 130B, 130C and 130D, such as thermocouples, are located in each zone of the bath 116. As shown in FIG. 2, a thermocouple 130A through 130D is located in the general vicinity of each respective heating element 128A through 128D. While the invention can be implemented with a single temperature sensor associated with each heating element, one of ordinary skill in the art will understand that it is possible to use additional temperature sensors in the vicinity of the respective heating elements for purposes of redundancy and averaging. It is also desirable to inject pressurized air into the water bath 116 to facilitate even heating of the shell eggs in the respective stacks. The temperature sensors 130 are electrically connected to a programmable logic controller (PLC) 132, see FIG. 3.

FIG. 3 schematically illustrates the operation of a batch processing control system 134 to control both the temperature of the water in the bath 116 near the respective heating elements 128A through 128D as well as the movement of the advance motor 135 to advance the batches 112A, 112M from stage to stage and zone to zone. The PLC 132 is programmed in accordance with a predetermined pasteurization protocol for batches of eggs having the designated size and start temperature.

The PLC 132 preferably contains uploaded software in a machine readable form on a data storage device or in memory that is able to implement a plurality of predetermined pasteurization protocols, each being statistically verified, and each being customized for a distinct combination of egg size and start temperature, and in accordance with the invention whether the shell eggs have not been refrigerated and/or have been appropriately tempered to room temperature (or higher) in order to justify the use of a time and temperature protocol taking advantage of lower D-values. For example, the controller 132 may contain six formulas: one pair of formulas for full batches of Medium sized eggs with one for refrigerated eggs with a start temperature of 45° F. and the other for unrefrigerated eggs with a start temperature at room temperature; a second pair of formulas for full batches of Large sized eggs with one formula for refrigerated eggs with a start temperature of 45° F. and the other for unrefrigerated eggs with a start temperature at room temperature; and a third pair of formulas for full batches of ex-Large sized eggs again with one formula for refrigerated eggs with a start temperature of 45° F. and another formula for unrefrigerated eggs with a start temperature at room temperature. Each formula will likely have a unique dwell time, as well as one or more unique target temperatures.

The water bath target temperature is desirably 133° F. (+/−0.5° F.). For example, the total dwell time for an unrefrigerated batch of Large eggs having a start temperature equal to room temperature (65° F.) may be 52 minutes, which means that each batch of eggs spends 13 minutes in each of the four zones as the batch 12 moves through the pasteurizer 116. In the system 110 shown in FIGS. 1 and 2, individual batches 118M would be placed within the pasteurizer bath 116 every four minutes and 15 seconds according to this hypothetical protocol, and each batch 118A-L would remain in each stage 120A-120C, 122A-122C, 124A-124C, 126A-126C for four minutes and 15 seconds. Referring again to FIG. 3, the PLC is programmed to hold each batch of shell eggs 112A-112M in each of the respective zones 114A-114D for the preselected period of time, and the PLC 132 will transmit a control signal to the motor advance 135 accordingly.

FIG. 3 shows the PLC 132 controlling one heating coil 128, although it should be understood that in the system illustrated in FIGS. 1 and 2 that the PLC 132 will independently control each of the 12 illustrated heating elements 128A-128D. In practice, it will likely be desirable for the system to have many more than 12 independently controller heating elements 128. As shown in FIG. 3, for each heating element 128, the PLC 132 receives a signal from at least one temperature sensor 130. In particular, an electronically controlled valve 138 controls the flow of heated water from the boiler 136 to the respective heating element 128. In other words, there is a separate electronically controlled valve 138 for each of the heating elements 128. Referring to FIG. 4, the PLC uses a proportional-integral-derivative (PID) algorithm, block 139, to control the operation of each heating element 128 independently. For example, in the system shown in FIGS. 1 and 2, the PLC will be programmed with 12 separate PID algorithms to control the operation of the heating elements 128. The temperature of the water in the vicinity of the respective heating element 128 is continuously monitored by the respective temperature sensor 130. The loop time for the PID algorithm is preferably five seconds although other loop times may be used in accordance with the invention. PID algorithms are generally known in the art. The set point temperature value for the heating element is defined by the predetermined pasteurization protocol. The difference between the set point temperature value and the temperature feedback signal from the temperature sensor 130 results in an error signal that drives the PID algorithm 139. The error signal drives the PID algorithm to generate a control signal that is transmitted to the valve control 138. The proportional aspect of the PID algorithm pertains to the severity of the error gap and uses a constant to calculate the amount of time the valve should be open to eliminate the gap. The integral aspect essentially measures how long the error gap has occurred, and the derivative aspect measures the rate of change of the proportional aspect. Each of these various aspects is combined to generate a control signal transmitted to the electronic valve 138 for each cycle of the loop. Preferably, the control signal is a value between zero and one and represents the percentage of time that the valve 138 will be open for the 5 second loop interval. For example, if the generated control signal from the PID algorithm is one, the valve will remain open to allow the flow of hot water to the heating element 128 for the entire 5 second cycle. On the other hand, if the generated control signal is only 0.8, the valve will be open for 4 out of 5 seconds. In this manner, the PLC 132 precisely controls the operation of each individual heating element 128, thereby preventing large swings in temperature.

A separate PID algorithm is used to control the temperature of the water supplied by the boiler 136, for example at about 170° F.

While the set point temperature value is a precise target value for the temperature of the bath in the vicinity of the respective heating element 128, the predefined pasteurization protocol will normally include a defined range, for example a half of degree Fahrenheit above or below the set point temperature value which is acceptable for implementing the protocol. The use of the multiple individually controlled heating elements is normally effective in maintaining the temperature of the fluid pasteurization medium within the desired temperature range. If, however, the temperature in one or more areas of the pasteurization bath approaches the upper control temperature, the PLC 132 will operate the cold water flow valve 140 to add cold water to the bath. Typically, there will only be one cold water valve, although in accordance with the invention there may be several. In any event, it is desirable that the operation of the cold water valve be controlled by a separate PID algorithm in the PLC, and if the system includes multiple cold water valves that each one be independently controlled.

The system also includes a level sensor 142 that senses the level of water in the pasteurizer. As in the prior art, if the water level drops below the location of the level sensor 142, the PLC 132 will add cold make up water by opening flow control valve 140. When this occurs, it will also normally be necessary for the controller 132 to control the boiler 136 and hot water flow control valves 138 to provide hot water to the heating coils 128 in order to maintain the temperature of the bath within the accepted temperature range for the given protocol programmed on the PLC 132.

FIG. 3 also illustrates a compressed air source 144 along with a control valve 146 to control the level of compressed air being supplied to the pasteurizer bath 114. The PLC 132 can optionally control the flow control valve 146 for the compressed air in accordance with the predetermined pasteurization protocol programmed on the PLC 132.

Several manufacturers make PLCs 132 suitable for this application. The PLC 132 preferably receives data from and transmits data to operational components of the system (e.g. sensors 130, 142; valves 138, 140, 146; motor advance 135; boiler 136; and alarm 152, 154) at a sampling rate of one sample per five seconds or faster. The PLC 132 preferably also includes a communications port that is capable of communicating with a conventional personal computer 148. FIG. 3 shows the computer 148 communicating with the PLC 132 via dashed line 150. It should be understood that the computer 148 may communicate by any number of means with the PLC 132, such as over an internal network, over an internet connection, wirelessly, etc. In addition, while it may be desirable to have the computer 148 on-site at the pasteurization facility, the computer 148 or one or more additional computers 148 may be located remotely. Typically, the computer 148 will have a display and a user interface such as a keyboard and mouse or a touch screen whereas the PLC 132 might not have a display and user interface. The PLC 132 will typically be programmed via the communication link 154 between the computer 148 and the PLC 132. Desirably, the computer 148 receives data from the PLC 132 for each batch of shell eggs being pasteurized. Also, desirably real-time data from the temperature sensors 130A-130D, the status of the heating and/or cooling system, the flow rate of compressed air 146, and optionally the status of advance motor 135 are provided to the computer 148 in real-time. The real-time data can be viewed on the remote computer 148, and can also be stored for later use if necessary.

As mentioned above, the invention can be implemented with a fluid pasteurization medium or combination of heating techniques different from immersion into a heated water bath as described in connection with FIGS. 1-4. For example, U.S. Pat. No. 6,455,094 entitled “Treatment of Food Products Using Humidity Controlled Air,” by Hershell Ball et al., issuing on Sep. 24, 2002, incorporated herein by reference; discusses heating and pasteurizing shell eggs with humid air, although at temperatures higher than 133° F. The come-up time is the amount of time for the temperature of the shell eggs to rise from the start temperature (e.g. refrigerated to 40° F. or non-refrigerated at room temperature, 65° F. or 70° F.). Come-up time in a heated water bath will normally be slightly faster than with humid air and likely more uniform than with humid air as described in the incorporated '094 patent. Come-up time with heated dry air convection should be longer and likely more inconsistent than humid air. Therefore, even if one wishes to use humid air or dry air convention heat, it may be desirable to initially heat the eggs with heated water (e.g. water heated to 133° F.). On the other hand, certain jurisdictions do not allow shell eggs to be submerged in water prior to sale because the water washes away the protective cuticle on the surface of the shell. In those jurisdictions, humid air and/or convection dry air heat at a temperature of no higher than substantially about 133° F. (±0.5° F.) may be useful.

### Example 1

### Quality Testing

Albumen quality of Large shell eggs pasteurized in a circulating water bath was tested for breakout appearance, turbidity and whipping time to peak height using different pasteurizing times (42, 43, 44, 45, 46, 47, 48, 49, 50, 51, 52, 53, 54, 55, 56, 57, 58, 59, 60, 61 and 62 minutes). Albumen quality of Large shell eggs pasteurized in a circulating water bath at 134° F. (±0.5° F.) for 50 minutes were compared to the large shell eggs pasteurized at 133° F. The temperature of the water bath was set at 133° F. or 134° F., and the water was preheated to the set temperature. Once the water reached the required temperature, Large raw eggs in the plastic flats were introduced into the water bath and pasteurized for the respective times.

The initial temperatures of the eggs were at 71.4° F. (average of 2 eggs). Once the water reached the 133° F. set temperature, Large raw eggs in the plastic flats were introduced into the water bath and pasteurized for the respective times—42, 43, 44, 45, 46, 47, 48, 49, 50, 51, 52, 53, 54, 55, 56, 57, 58, 59, 60, 61 and 62 minutes.

Initially, the water bath was loaded with 9 flats of eggs. The first flat was pulled at 54 minutes followed by pulling one flat out at every minute until 62 minutes. The temperature of the bath was verified to be at 133° F. and 9 more flats were loaded with the first flat pulled at 45 minutes followed by pulling one flat every minute until 53 minutes. The water bath then loaded with 6 flats of eggs and one flat was pulled out at 42 minutes, 43 minutes and 44 minutes.

For shell eggs having a starting temperature at room temperature (70° F.), 60 minutes in the 133° F. water bath is sufficient to achieve a 5-log reduction of Salmonella Enteritidis throughout the egg using the model set forth in the Davidson '538 patent. In the Davidson '538 patent, D values calculated on data collected in SE inactivation studies are defined as:

D-value(T)=10̂(−0.11245*T+15.924), (1)
where D-value(T) is the number of minutes to achieve a one log kill of SE at the given temperature T.

According to Eq. (1), the D-value (133° F.) is 9.29 minutes. Accounting for SE reduction during come-up time once the yolk temperature reaches 128° F., assuming a 70° F. start temperature, a 5 log reduction of SE is achieved in a 133° F. water bath in 60 minutes. Analysis of the data leading to Eq. (1) has indicated that Eq. (1) conservatively results in higher D-values than other statistically acceptable data fits. In addition, there is now evidence that D-values for SE reduction in the yolk of shell eggs that are not refrigerated at the start of the pasteurization process have substantially lower D-values, see co-pending U.S. Provisional Application No. 62/169,740, entitled “Improved Shell Egg Pasteurization Process,” filed on Jun. 2, 2015 by Hector Gregorio Lara, Erdogan Ceylan. While it is possible that testing and data analysis may find that less time than 60 minutes is required to achieve a 5 log reduction of SE, the testing disclosed in the present application establishes albumen quality for shells eggs deemed to be pasteurized conservatively in accordance with Eq. (1) which requires 60 minutes at 133° F.

For pasteurizing the eggs at 134° F., the pasteurizer is set to 134° F. and once the water was heated to the set temperature, Large eggs in plastic flats were placed in the water bath and pasteurized for 50 minutes. The eggs in the flats were weighed and labelled with the measured weight.

Break Out Appearance.

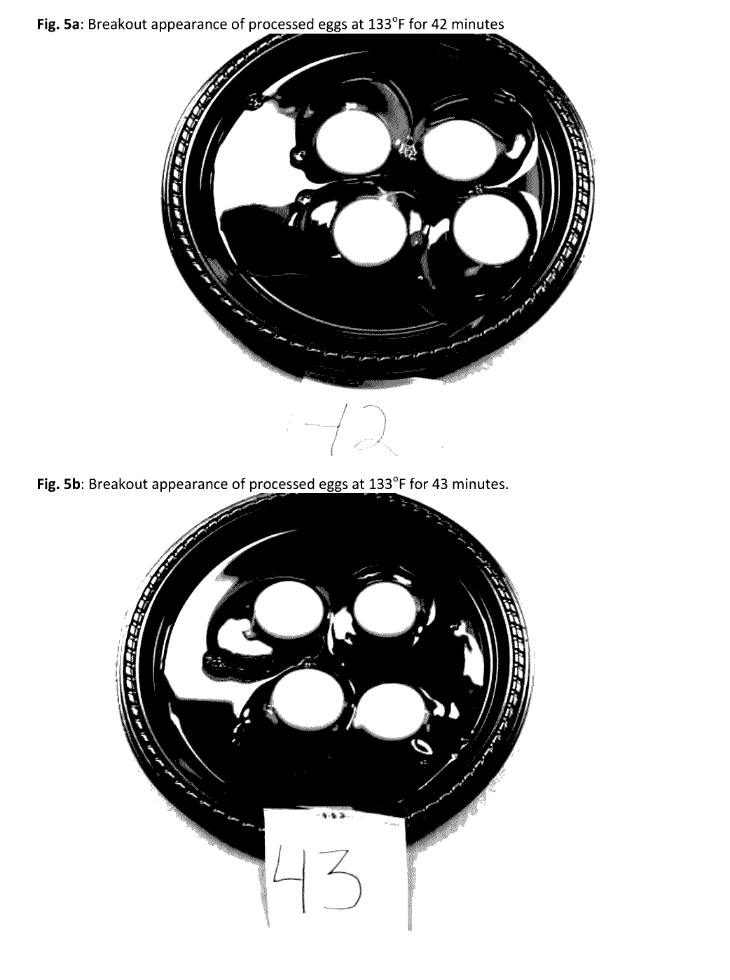

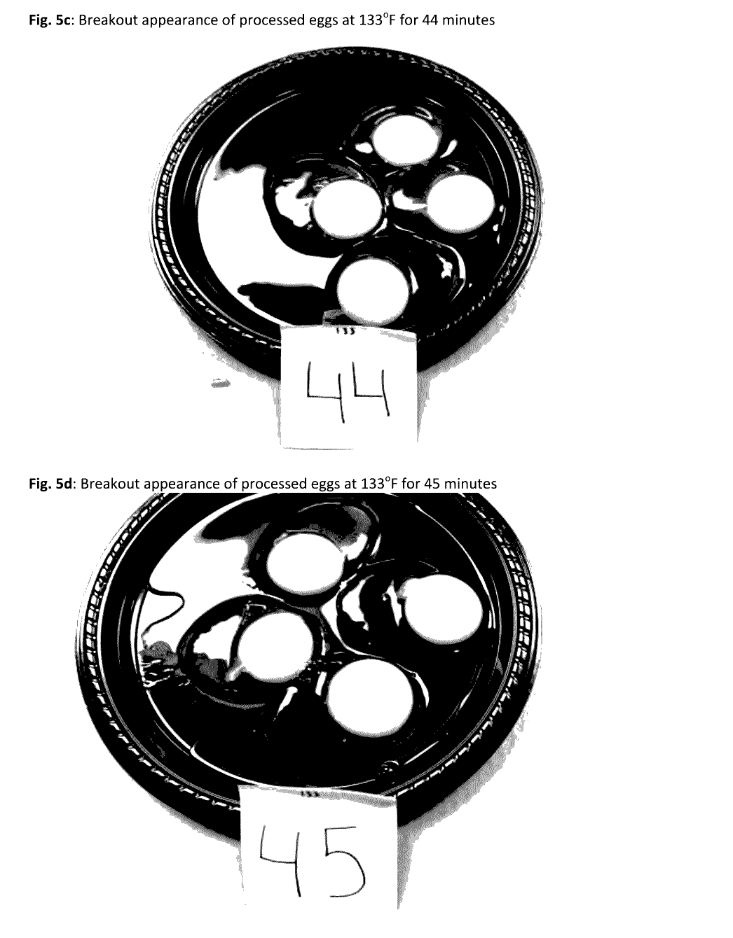

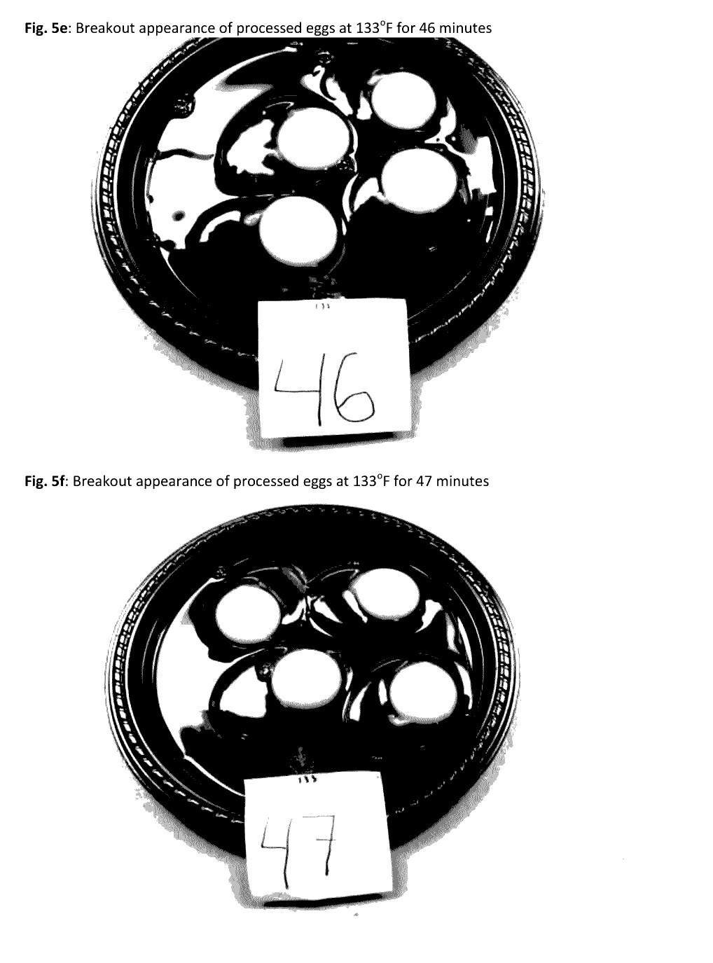

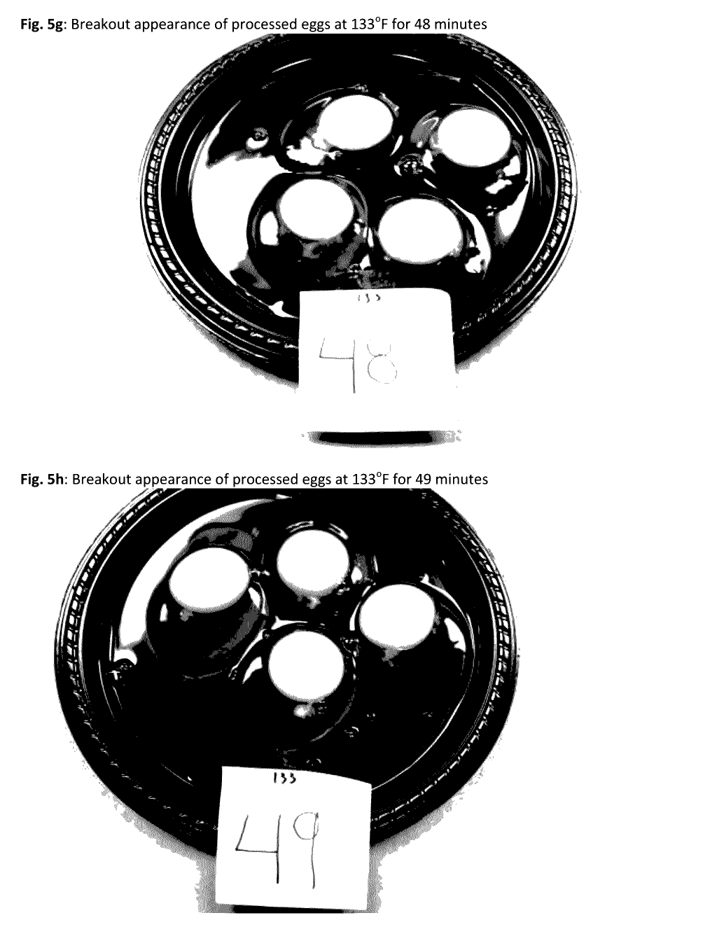

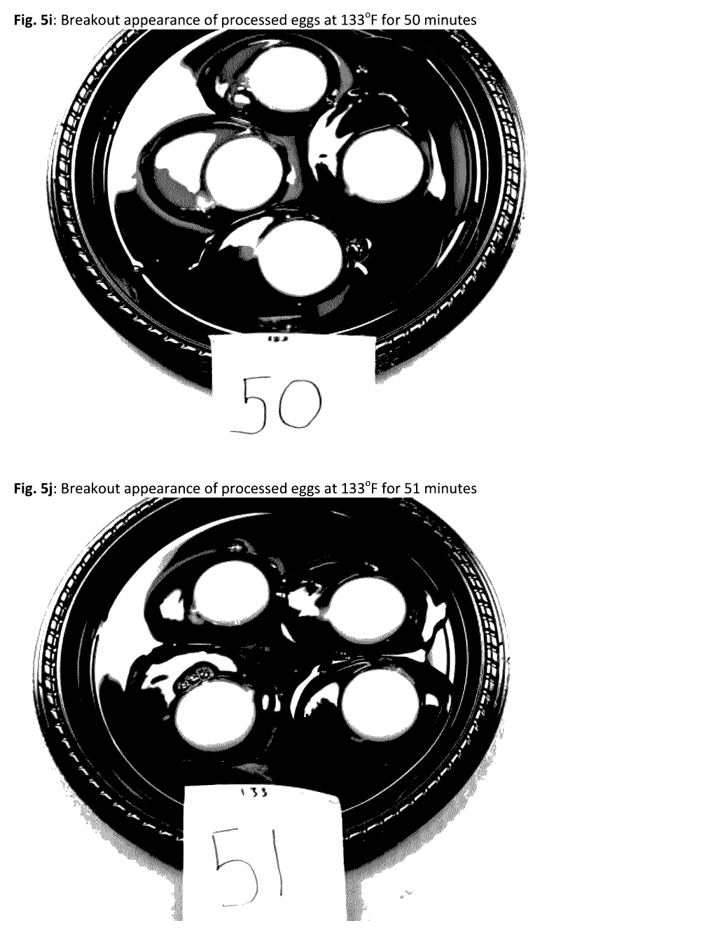

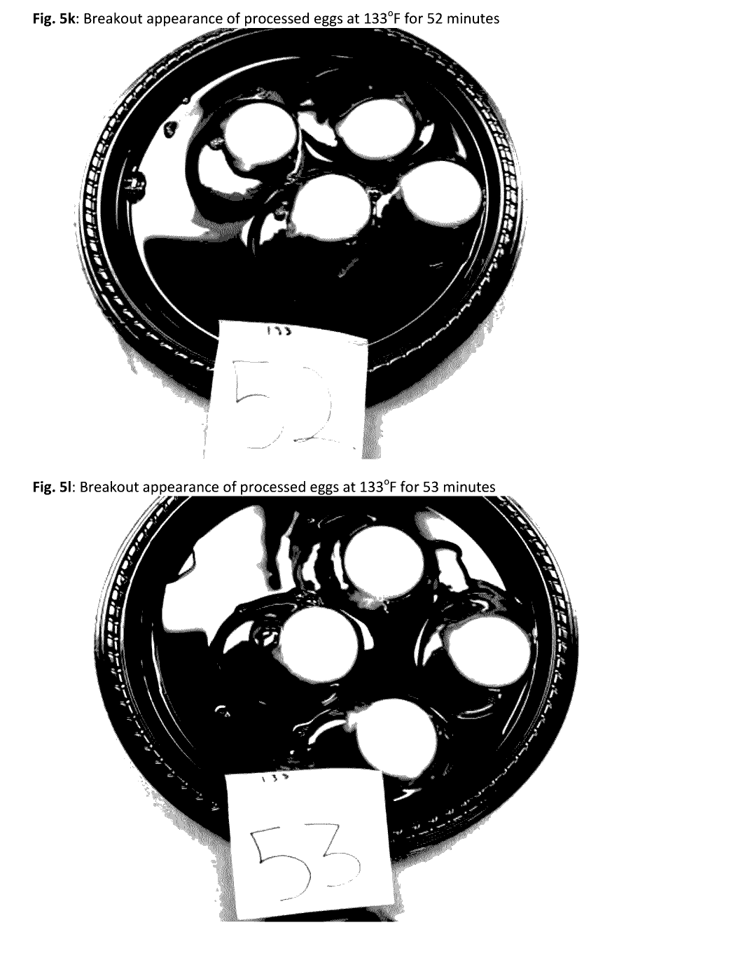

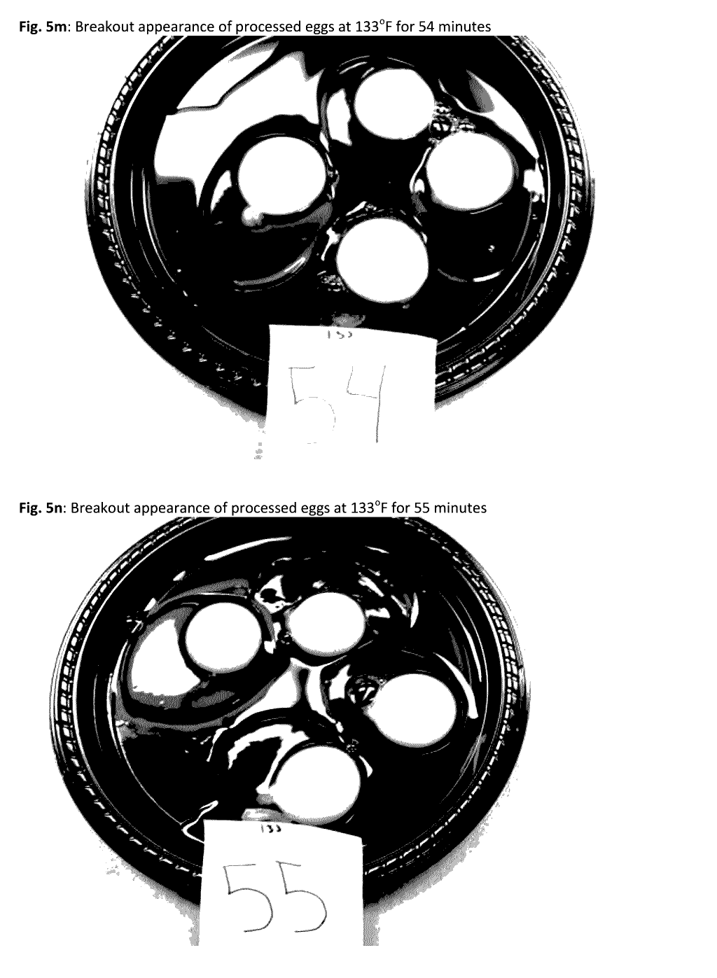

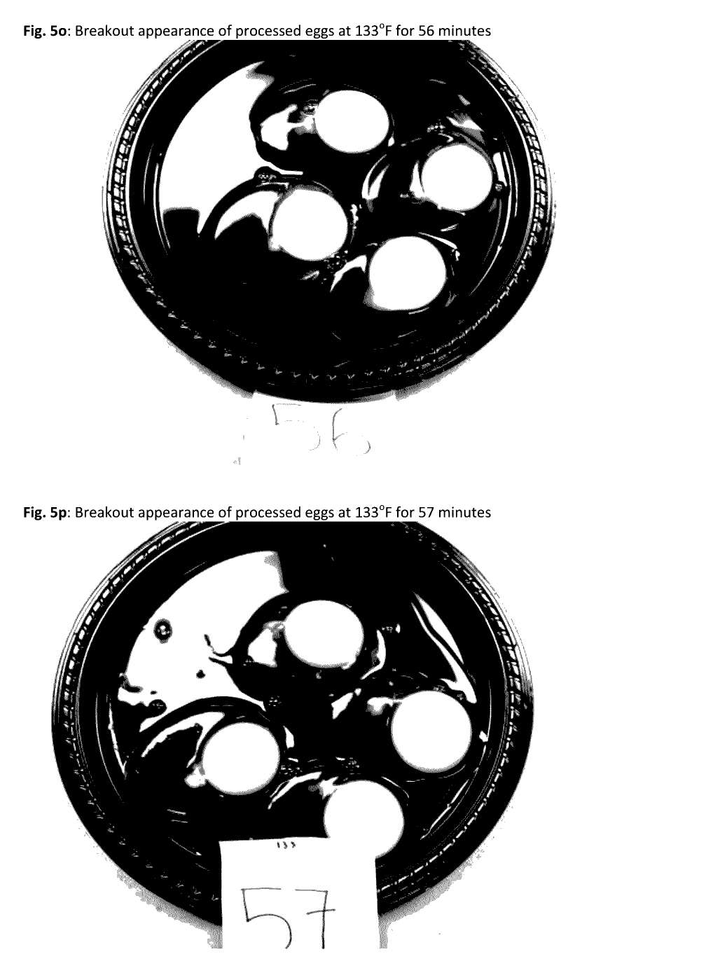

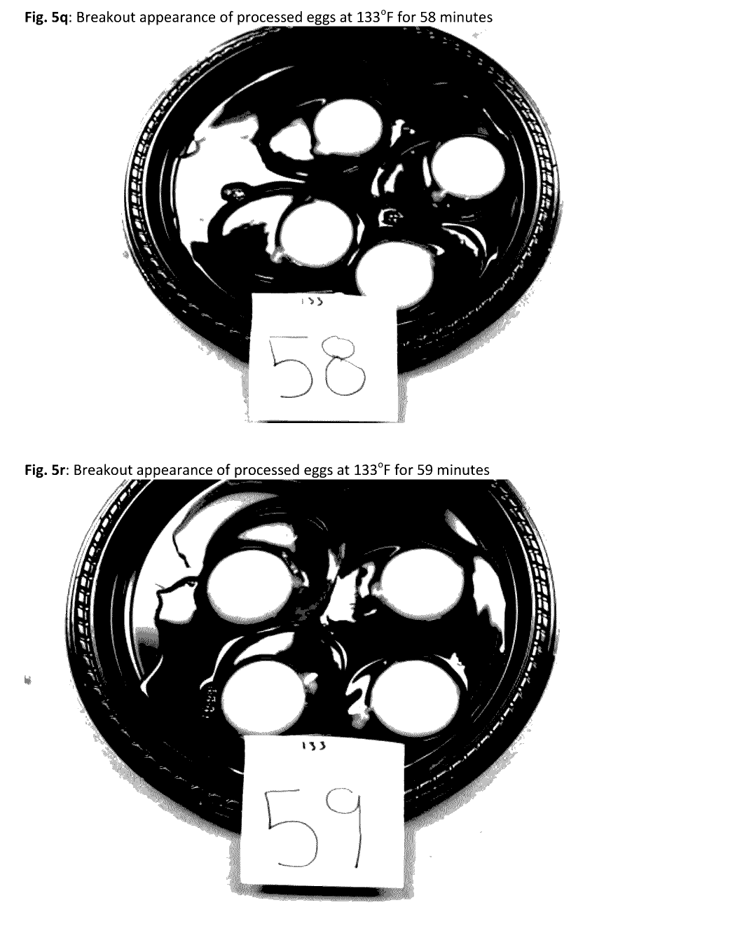

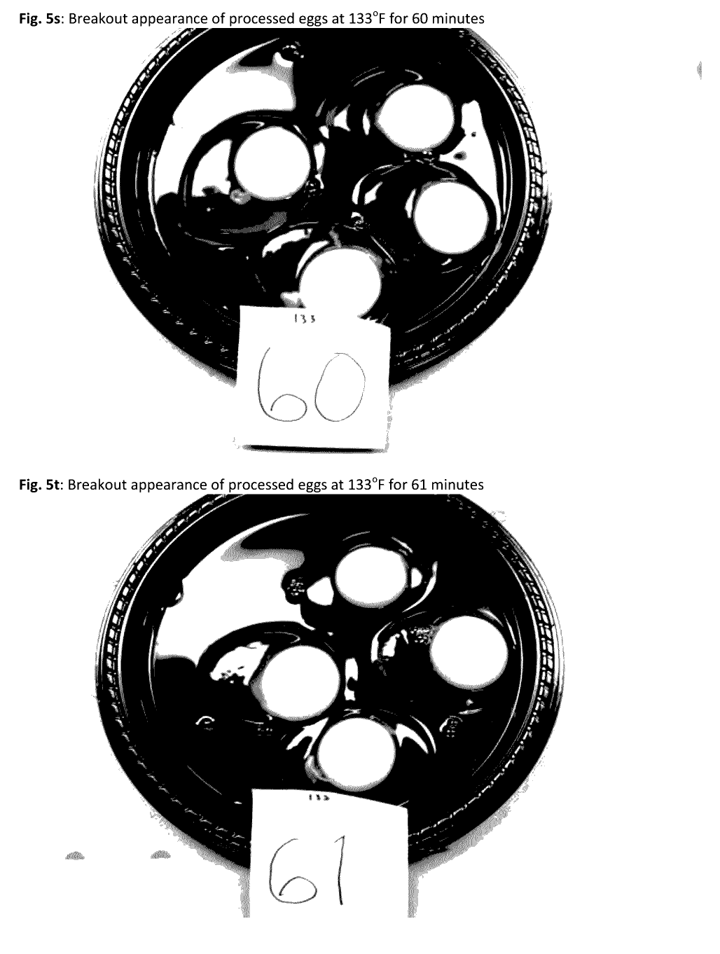

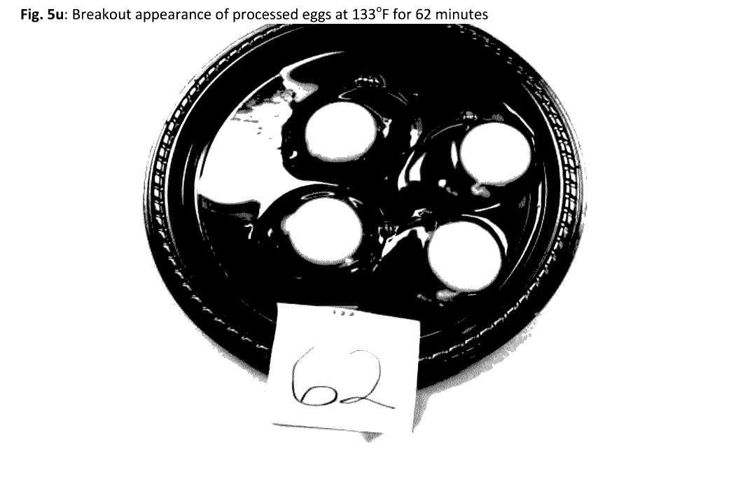

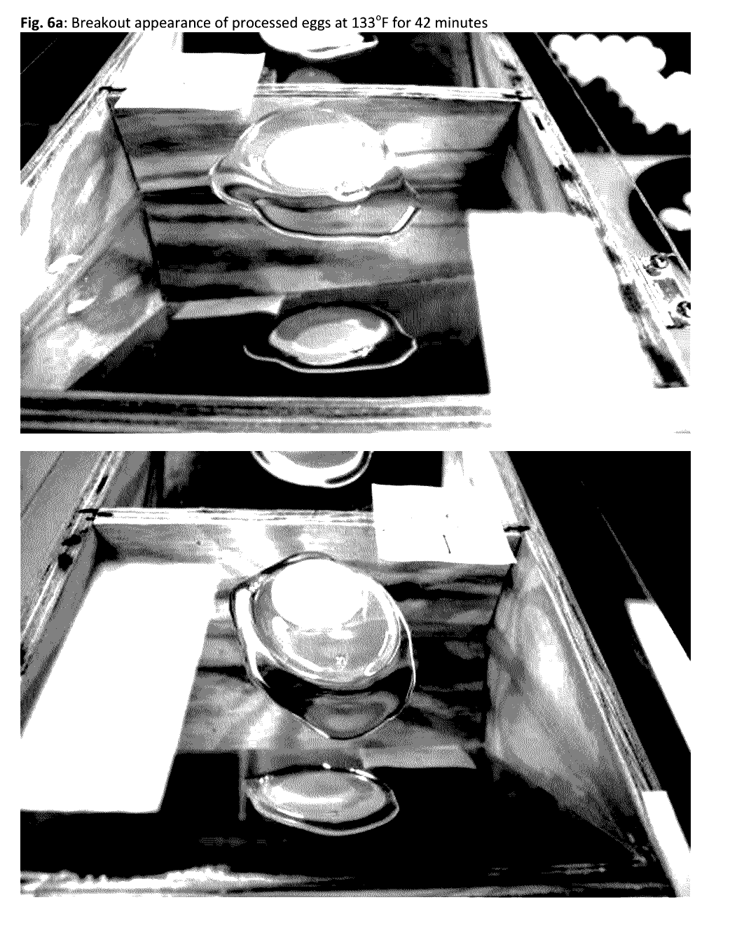

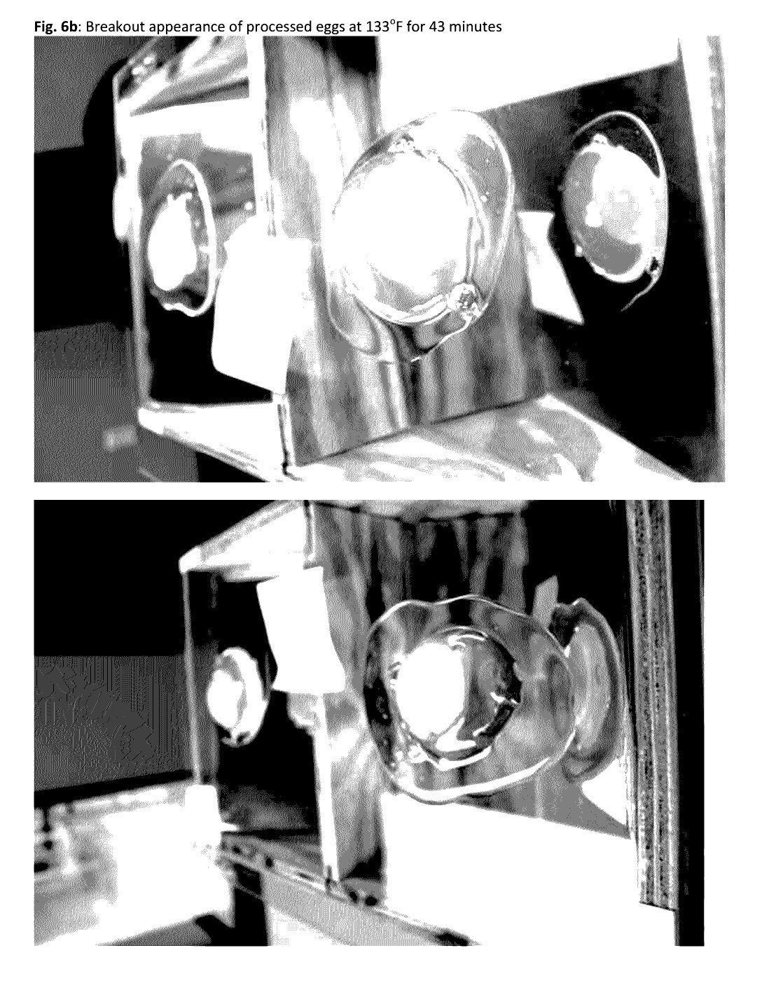

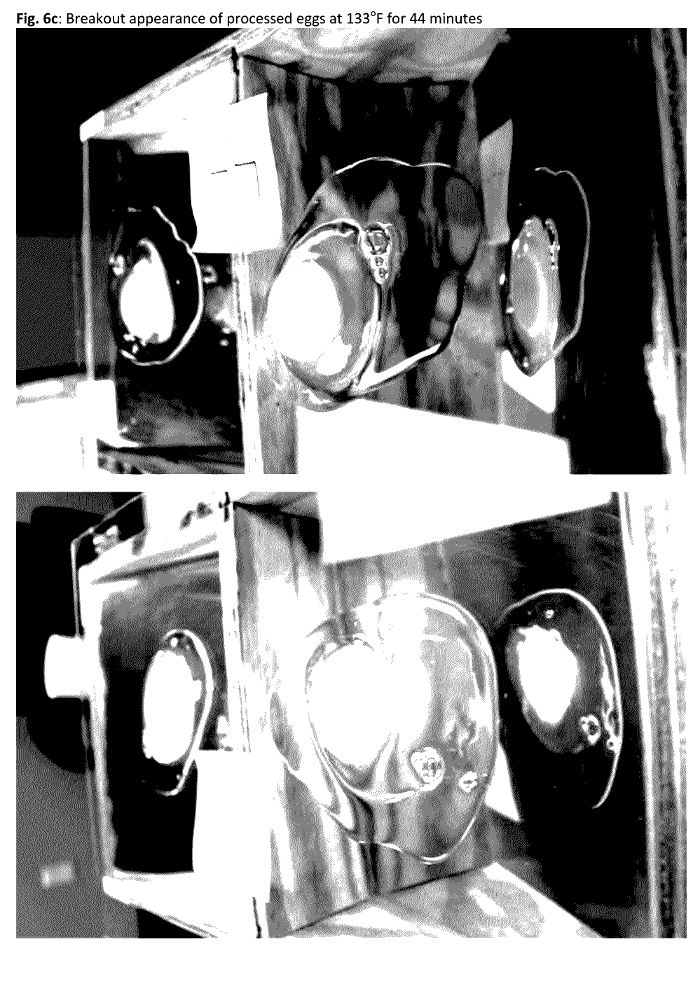

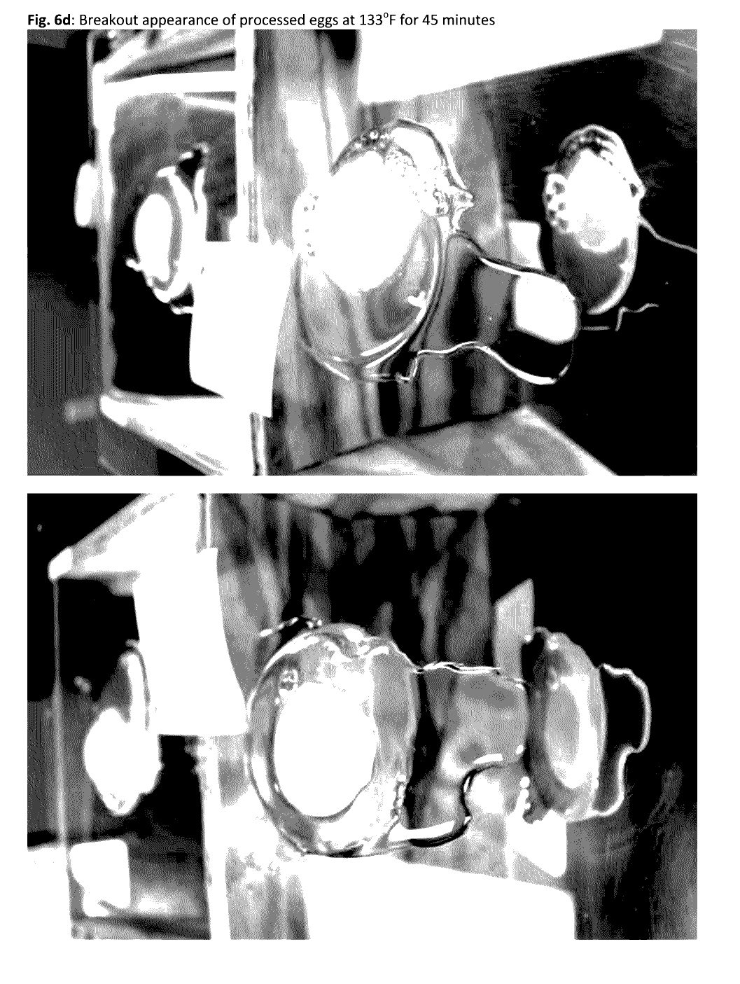

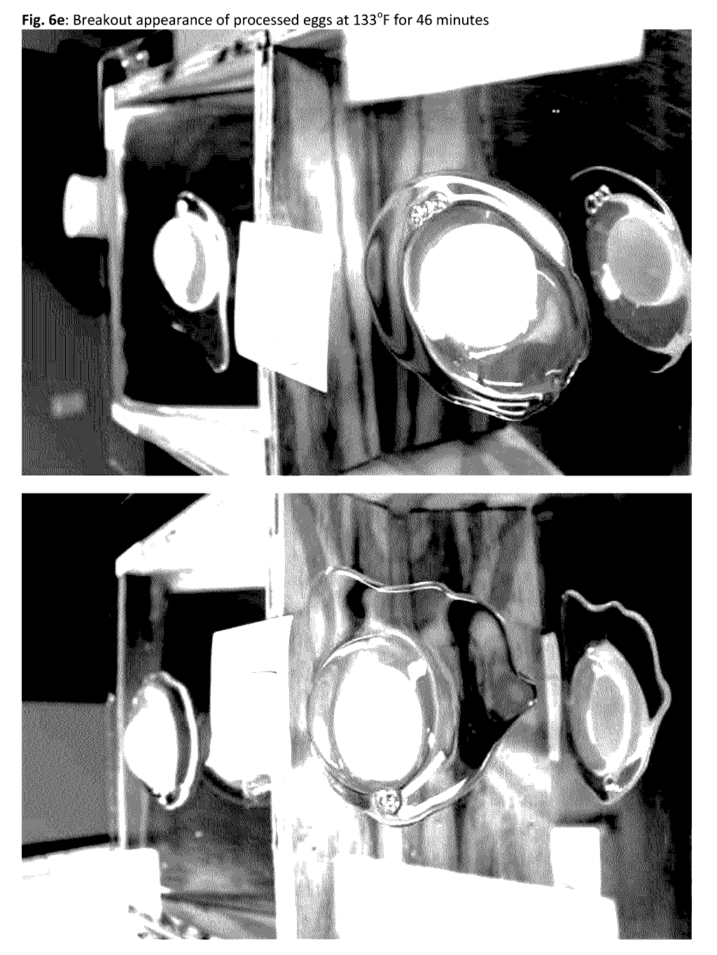

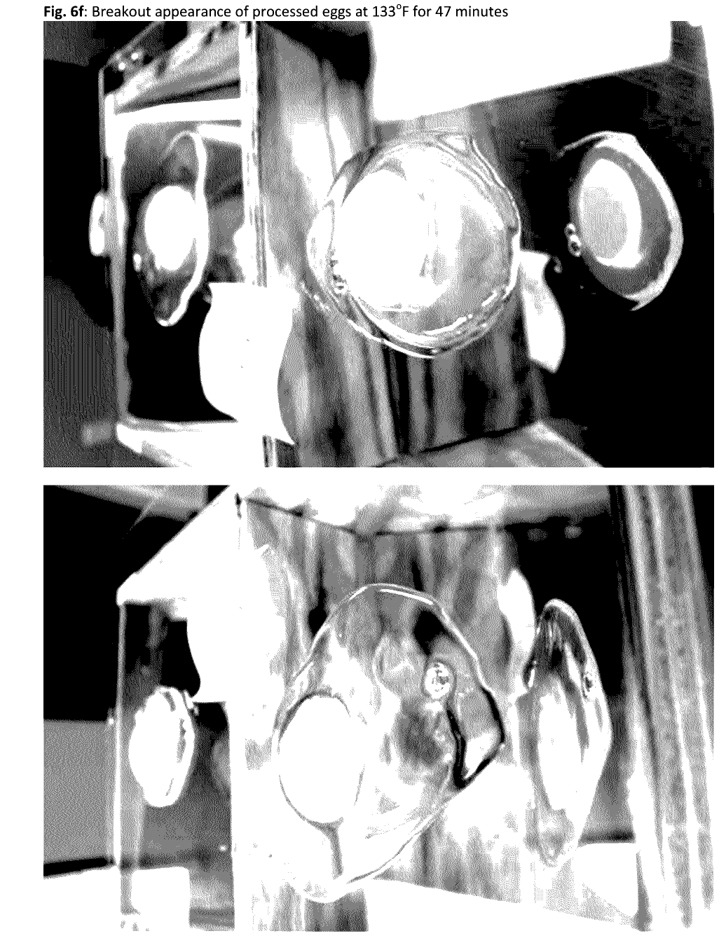

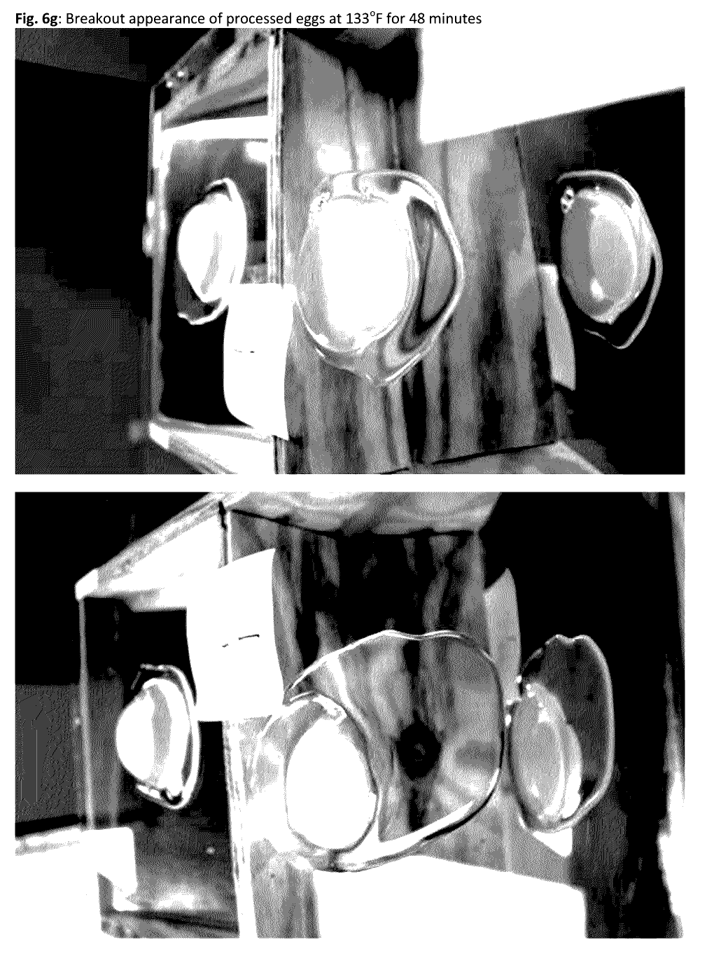

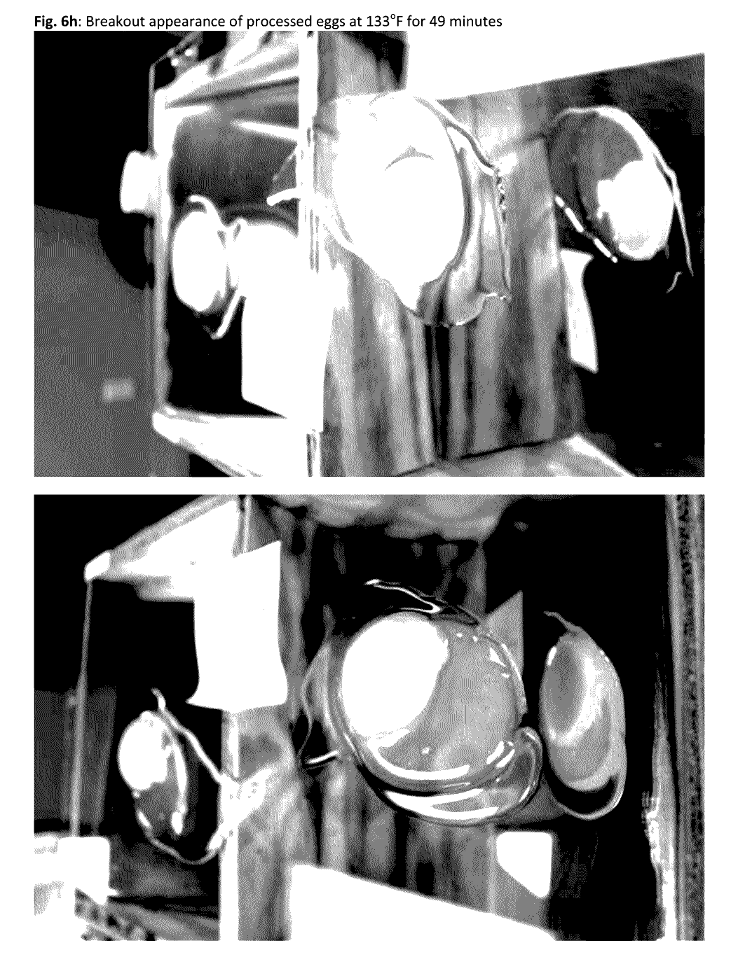

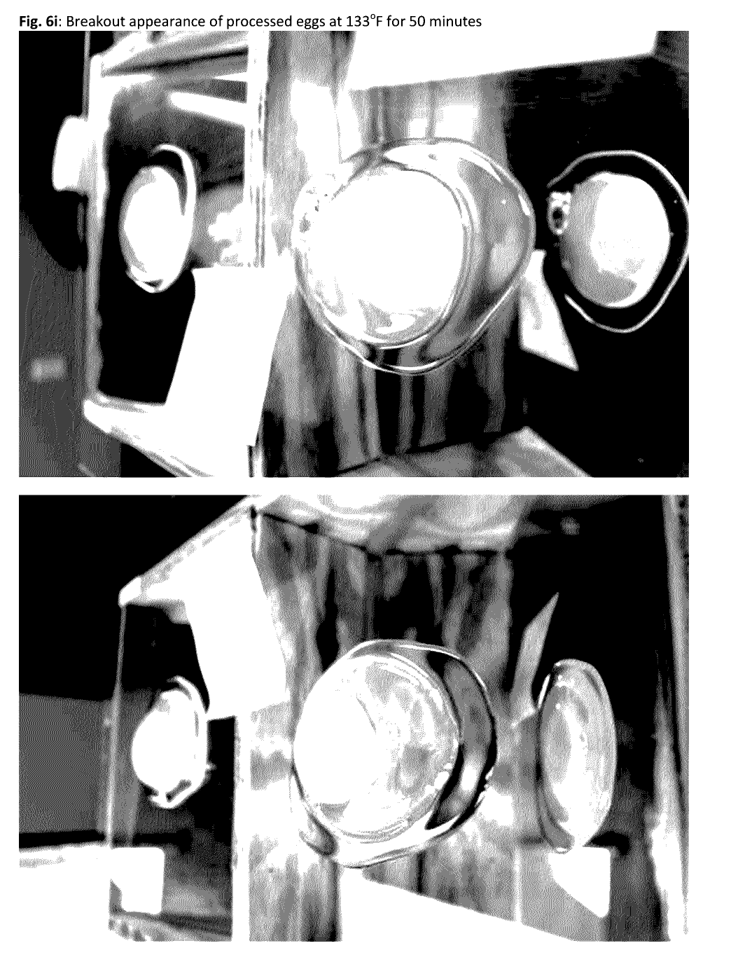

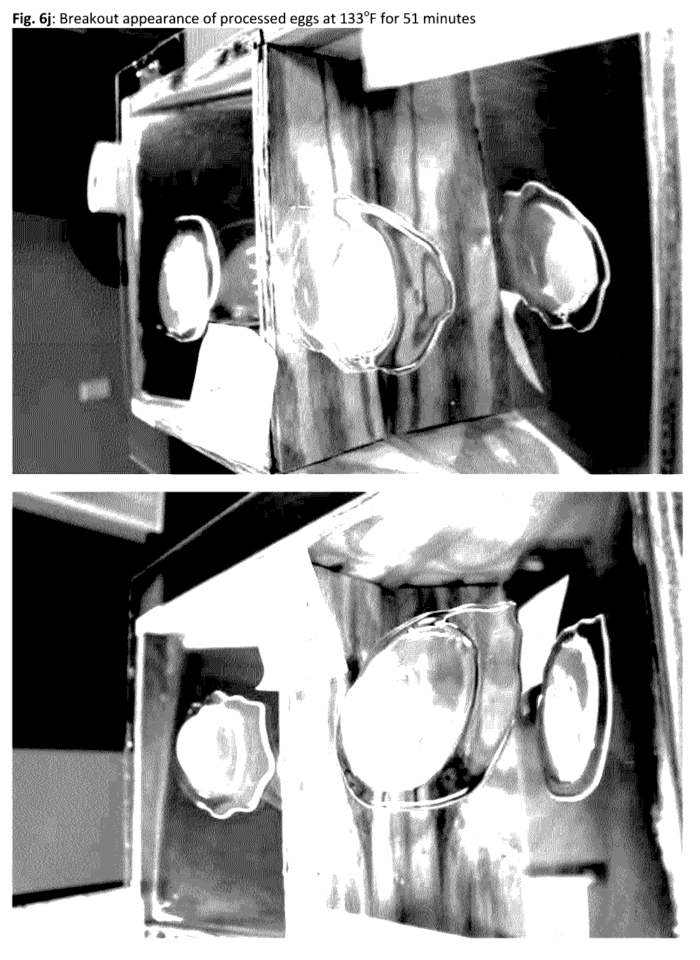

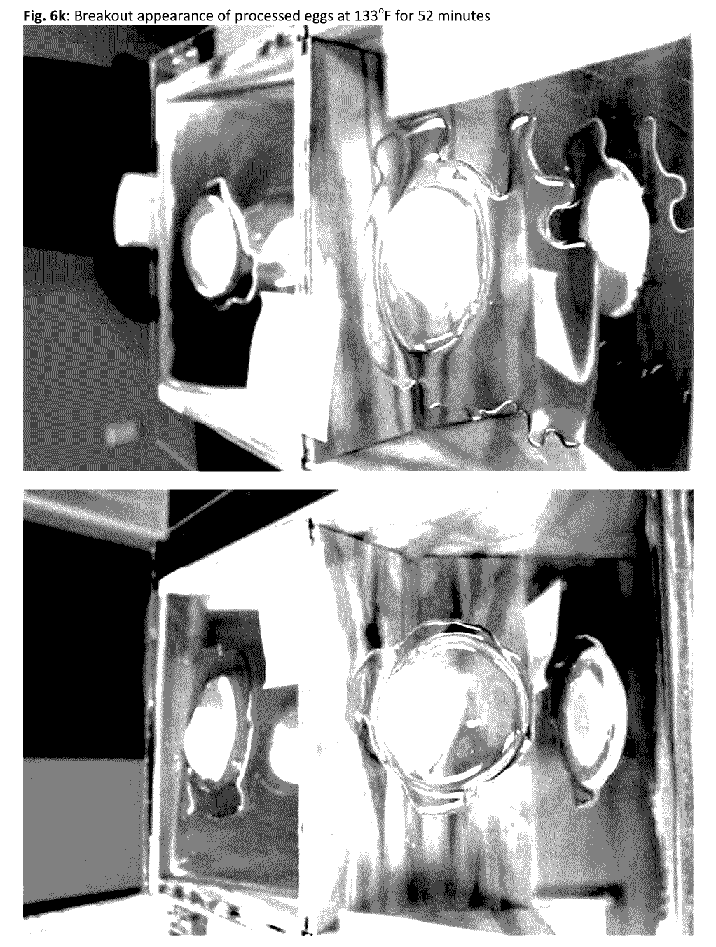

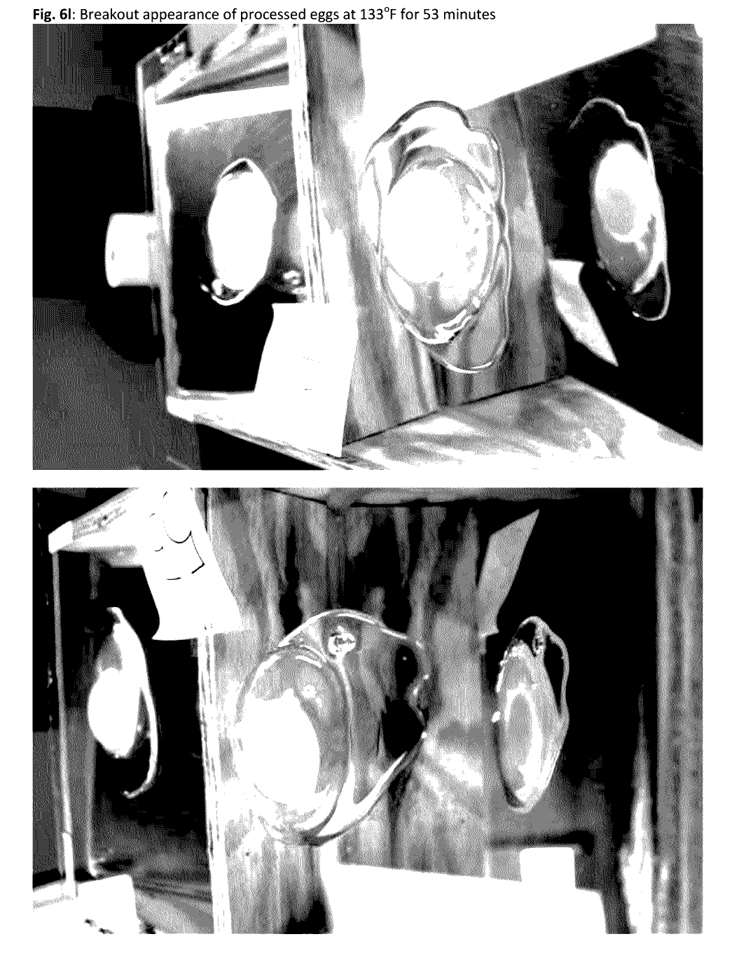

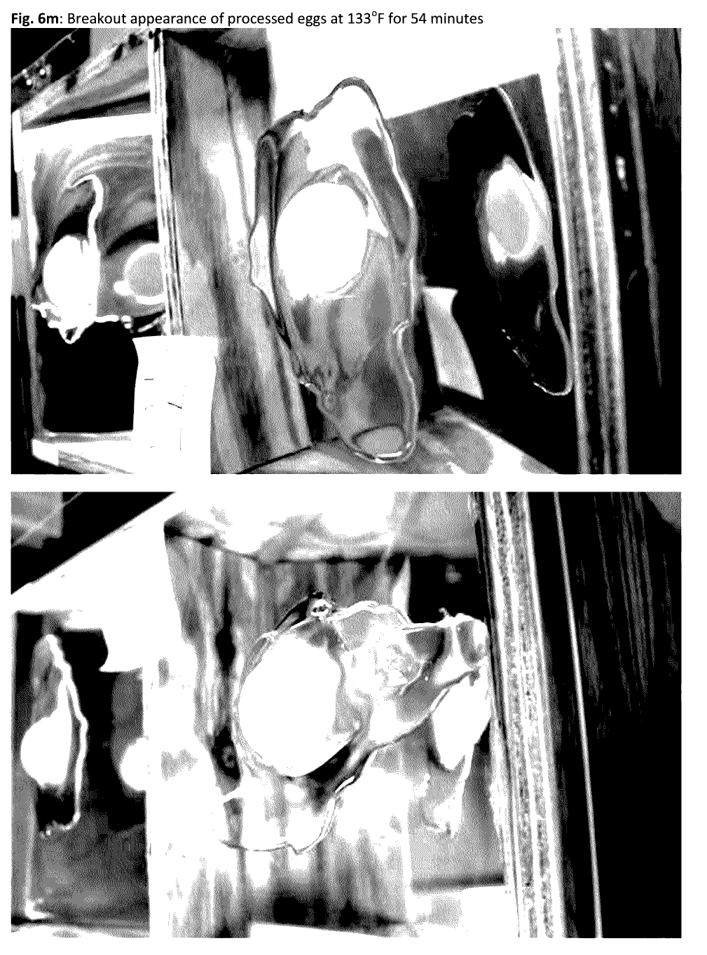

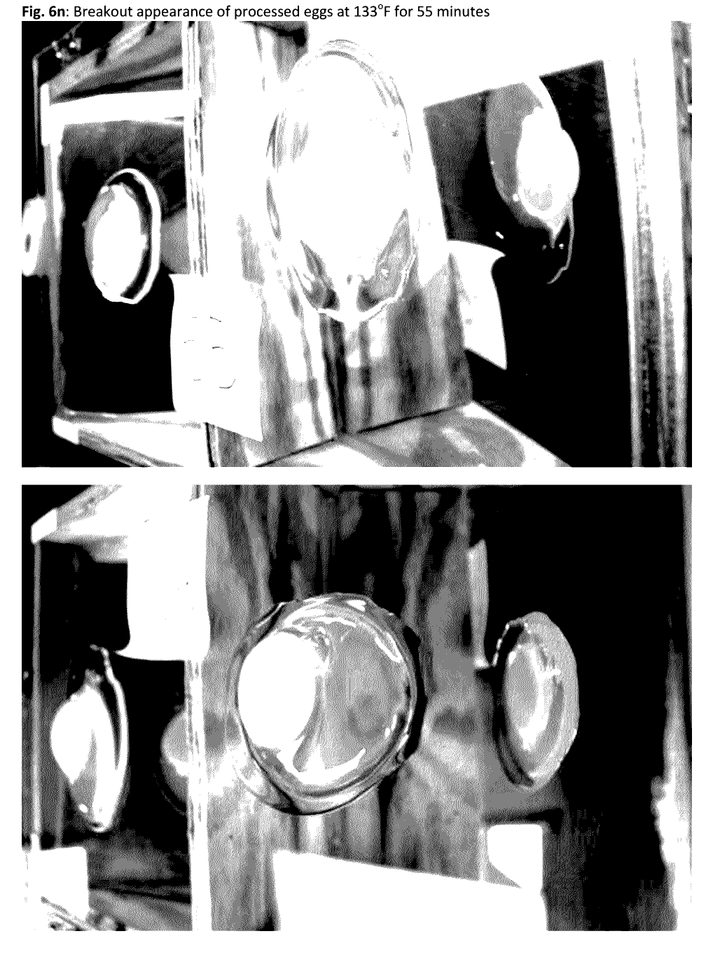

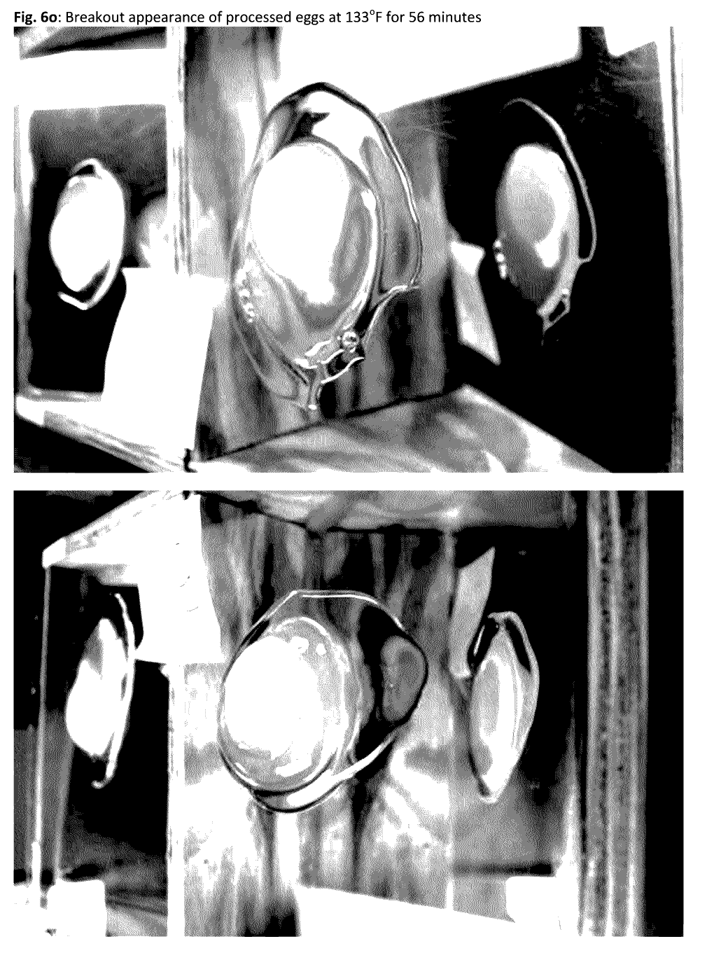

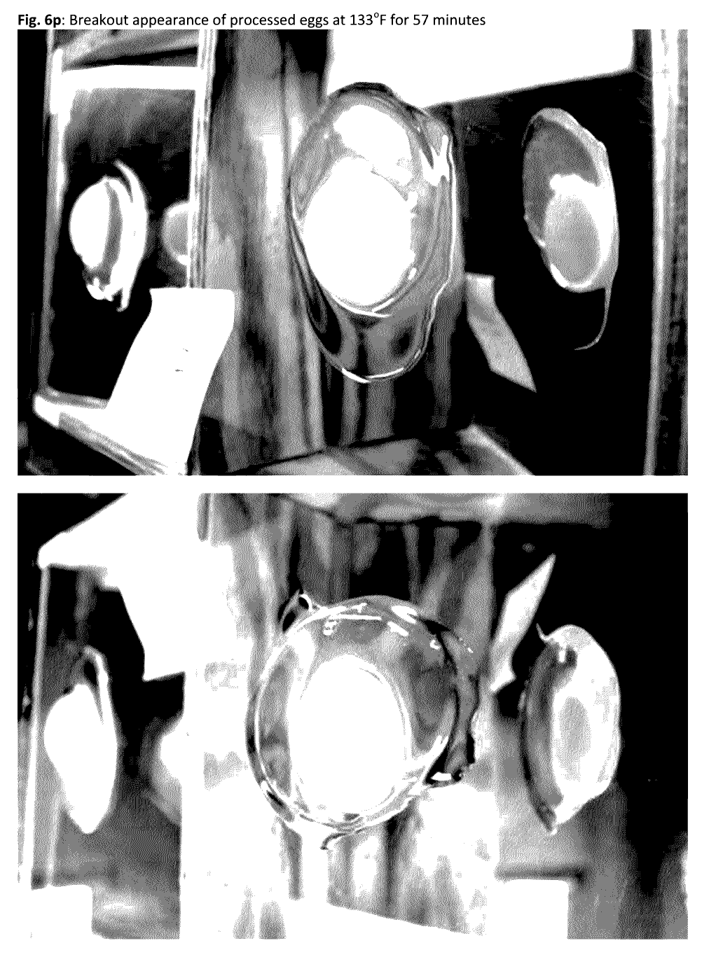

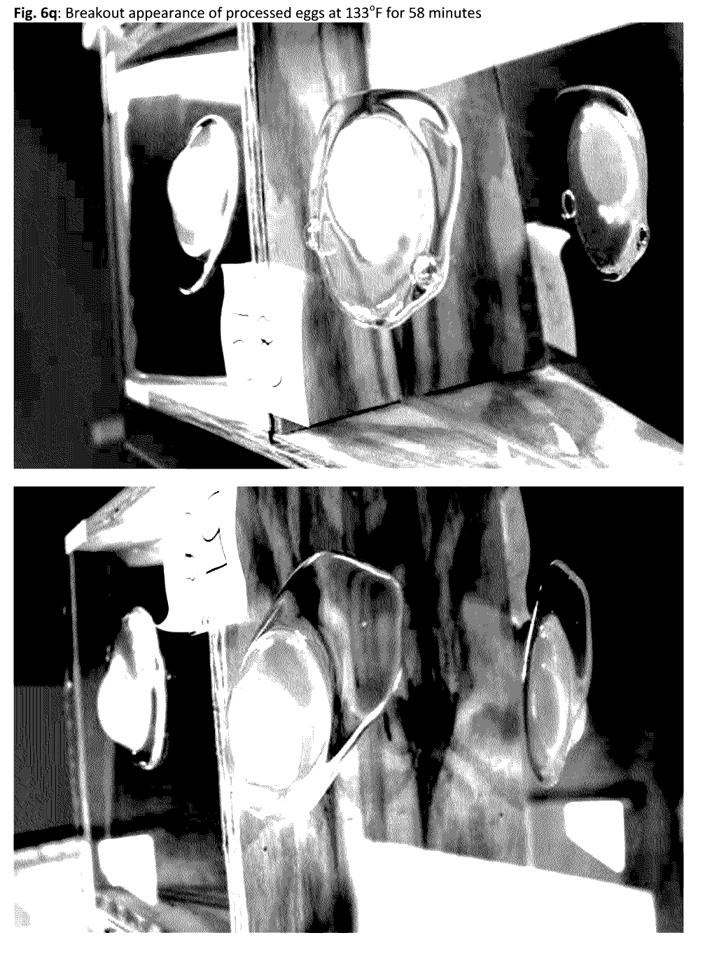

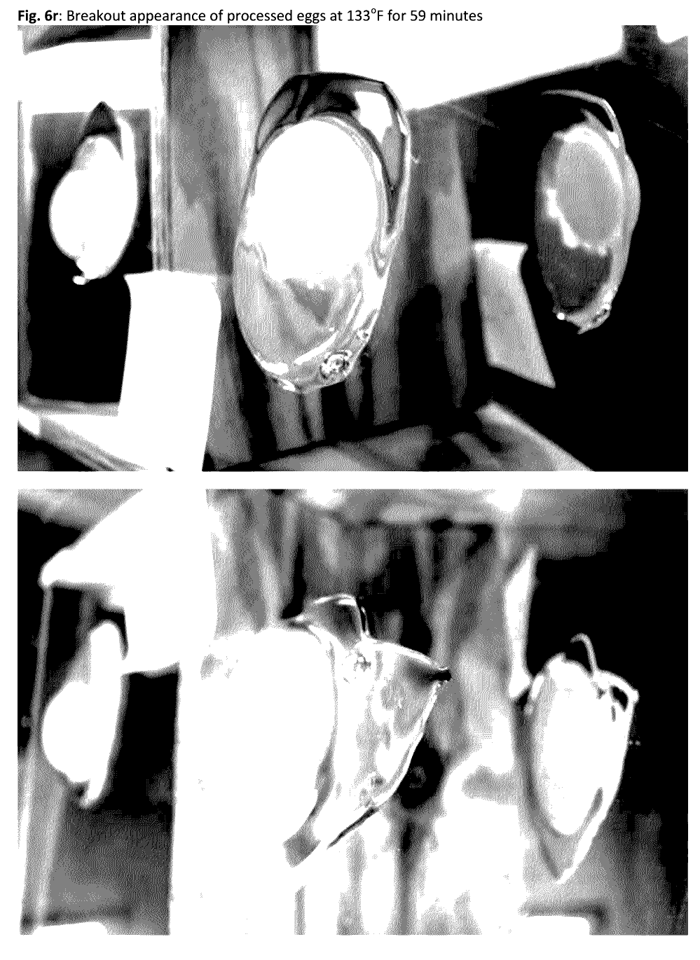

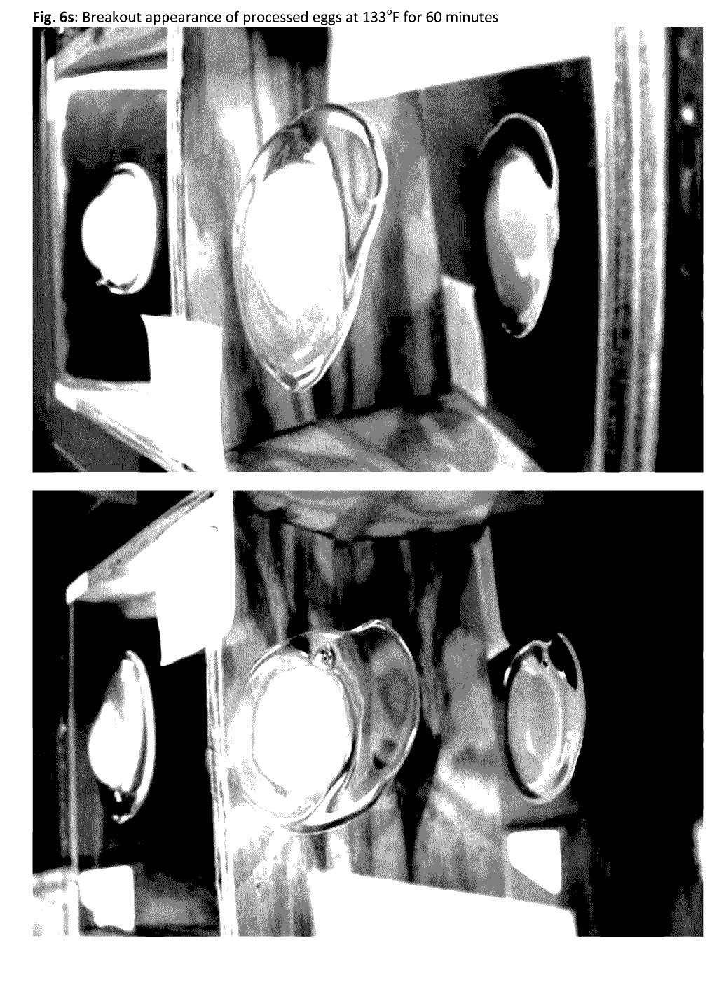

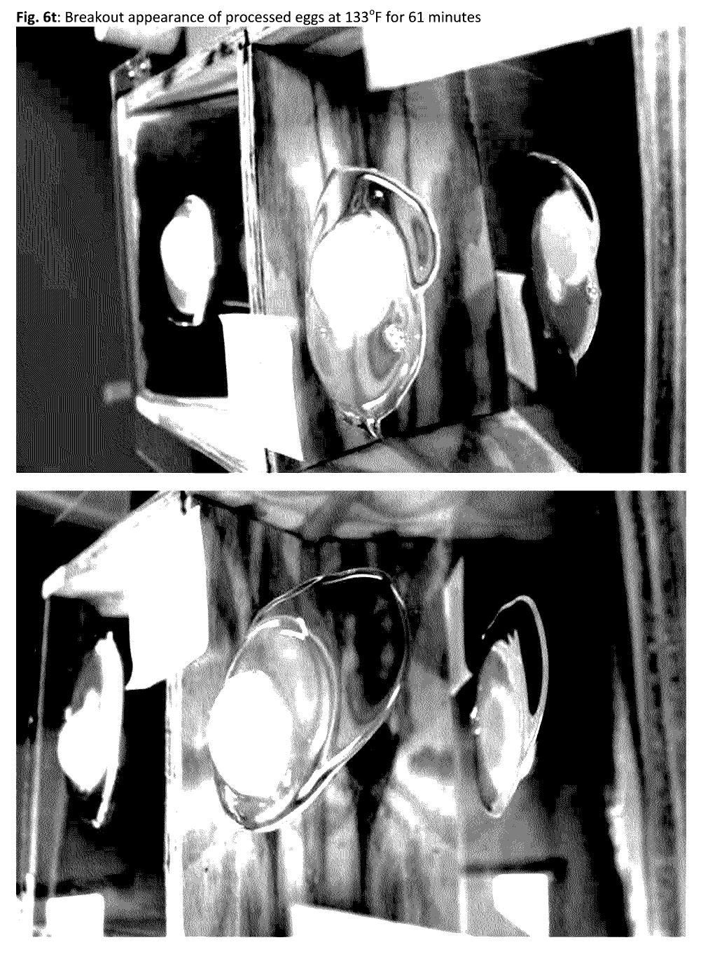

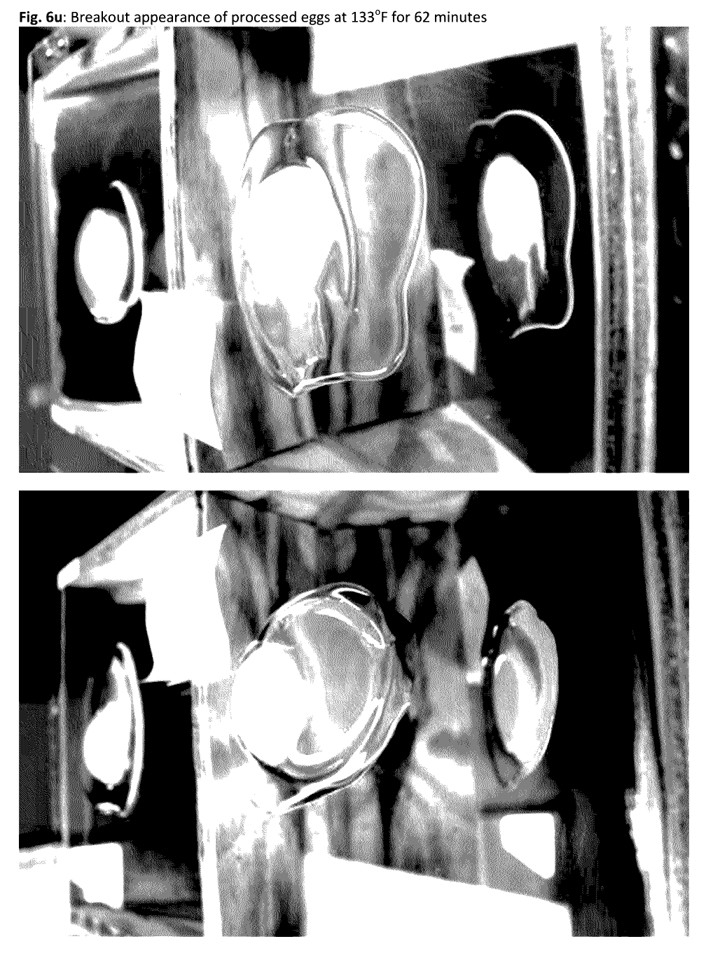

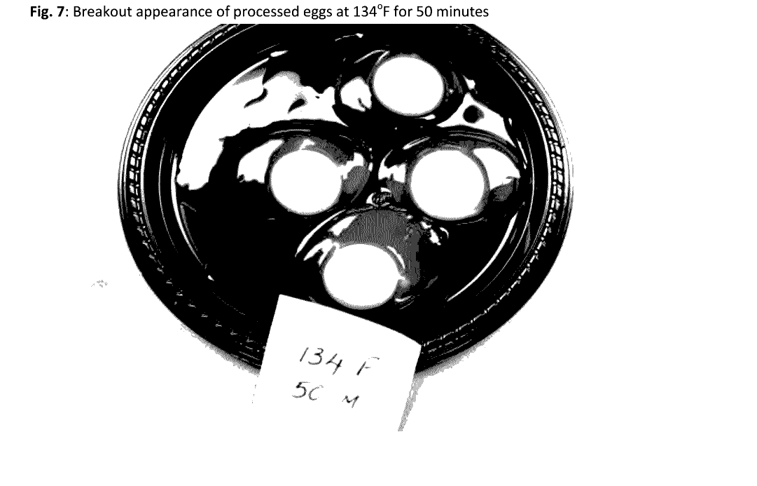

The test for break out appearance consisted of pulling eggs from the water bath at each pull time and breaking pulled eggs onto black plastic plates and taking photographs from straight above the broken out eggs. (See, FIGS. 5a through 5u for 133° F. water bath for 42 to 62 minutes; and FIG. 7 for 134° F. water bath, 50 minutes.) The break out appearance test also involved breaking pulled eggs on a mirror box and taking photographs from an angle, see FIGS. 6a through 6u for 133° F. water bath for 42 to 62 minutes. For this, six (6) eggs from the flat at each processing time were collected. Eggs with the most similar weight were selected. Four (4) eggs were broken onto the black plate and two eggs were broken on the mirror box. FIGS. 5a through 5u are color photographs of the break out appearance of the eggs at 133° F. for 42 through 62 minutes shown on black plates. FIGS. 6a through 6u are color photographs of the break out appearance of the eggs at 133° F. for 42 through 62 minutes shown on clear glass. FIG. 7 is a color photograph of the break out appearance of the eggs at 134° F. for 50 minutes shown on black plates.

After taking the photographs, the eggs on the black plates were used to check the turbidity. The weight range of the eggs used to perform the breakout appearance and turbidity were tabulated below in Table 3.

Turbidity.

For each pull time (133° F., 42 minutes through 62 minutes; 134° F., 50 minutes) the four (4) eggs that were broken onto the black plate to capture the breakout appearance photographs were carefully obtained. The whites were separated and blended in the lab blender (Seward Stomacher 400 C) for 30 seconds at 75 rpm. Then, 10 ml of the blended sample was collected into the glass cuvette and turbidity was measured using the bench top turbidity meter (Hanna Instruments Portable logging Turbidity meter). Two (2) vials were filled and each vial was measured 6 times. The average of all 6 readings was presented as the turbidity value for the recipe. The turbidity values for each pull in the 133° F. water bath are presented in Table 1. The turbidity value for the pull in the 134° F. water bath is presented in Table 2.

Whipping Time.

For each pull time, five (5) eggs having similar weights were selected. The whites were separated and collected into a mixing bowl, and whipped at the medium speed for 30 seconds and then speed was increased to maximum until the whites were whipped to peak height using the Kitchen Aid stand mixer and total whipping times were recorded. The whip time values for each pull in the 133° F. water bath are presented in Table 1. The whip time value for the pull in the 134° F. water bath is presented in Table 2. During the whipping, the mixer started to slow in the middle, which may have resulted in getting the longer whip times for some recipes. The performance of the mixer was described as normal, slow and slower next to the whip times on the table. The slow or slower means, that during the whipping time, the mixer operated with slow or slower speed for some time.

TABLE 1
Turbidity and whip times of the processed eggs at different
pasteurizing times at the pasteurizing temperature of 133° F.

| Pasteurizing times | Turbidity | Whip time | Mixer |
|---|---|---|---|
| (min) | (NTU*) | (min) | performance |
| 42 | 152 | 7:10 | Slow |
| 43 | 193 | 7:05 | Slow |
| 44 | 175 | 8:05 | Slow |
| 45 | 109 | 8:00 | Slow |
| 46 | 132 | 8:20 | Slow |
| 47 | 158 | 8:45 | Slower |
| 48 | 101 | 8:30 | Slower |
| 49 | 114 | 7:55 | Normal |
| 50 | 156 | 10:00 | Slower |
| 51 | 137 | 9:25 | Slower |
| 52 | 166 | 9:40 | Slow |
| 53 | 203 | 6:40 | Slow |
| 54 | 162 | 6:40 | Slow |
| 55 | 124 | 6:30 | Normal |
| 56 | 143 | 9:20 | Slow |
| 57 | 152 | 6:20 | Normal |
| 58 | 156 | 7:20 | Slow |
| 59 | 137 | 7:05 | Slow |
| 60 | 159 | 8:10 | Slow |
| 61 | 124 | 7:10 | Slower |
| 62 | 139 | 6:10 | Normal |

TABLE 2
Turbidity and whip times of the processed eggs
using current recipe (50 minutes at 134° F.)

| Pasteurizing times | Turbidity | Whip time | Mixer |
|---|---|---|---|
| (min) | (NTU*) | (min) | performance |
| 50 | 256 | 7:20 | Slow |

*NTU—Nephelometeric Turbidity Unit.

TABLE 3
The weight range of the eggs used to perform the
Breakout appearance and turbidity, and whip times

| Processing | Egg weight ranges used | |
|---|---|---|
| times | for breakout appearance | Individual egg weights |
| (minutes) | and Turbidity (grams) | used for whip times (grams) |
| 42 | 58.1-58.9 | 61.2, 60.9, 60.9, 58.6, 58.8 |
| 43 | 57.4-58.8 | 60.1, 61.0, 60.2, 61.3, |
| 44 | 58.1-58.8 | 61.3, 59.3, 59.0, 61.0, 57.9 |
| 45 | 58.1-59.3 | 60.3, 60.0, 59.3, 58.9, 60.1 |
| 46 | 57.7-58.6 | 59.7, 59.7, 59.6, 59.2, 57.1 |
| 47 | 57.6-59.4 | 60.7, 60.1, 59.8, 59.7, 59.7 |
| 48 | 57.7-59.3 | 60.8, 59.9, 59.8, 59.6, 59.5 |
| 49 | 57.3-59.0 | 61.7, 60.7, 60.1, 60.0, 59.9 |
| 50 | 57.9-58.8 | 57.6, 59.8, 59.7, 60.4, 60.4 |
| 51 | 57.1-59.0 | 60.3, 60.3, 60.2, 59.8, 59.8 |
| 52 | 57.3-59.0 | 61.4, 61.1, 61.1, 60.8, 60.7 |
| 53 | 58.3-58.9 | 59.4, 59.8, 59.5, 59.3, 57.1 |
| 54 | 57.9-58.8 | 61.2, 61.1, 60.3, 59.7, 57.4 |
| 55 | 57.7-58.8 | 60.1, 60.0, 59.8, 59.6, 59.0 |
| 56 | 58.3-59.0 | 59.9, 59.6, 59.6, 59.5, 59.5 |
| 57 | 57.3-58.9 | 59.7, 59.7, 59.8, 60.4, 61.0 |
| 58 | 57.6-58.8 | 59.5, 59.8, 59.9, 60.1, 60.5 |
| 59 | 58.0-59.0 | 60.8, 60.8, 60.5, 60.1, 60.2 |
| 60 | 57.5-59.0 | 61.0, 59.9, 59.4, 59.2, 57.5 |
| 61 | 57.9-59.3 | 61.1, 60.8, 60.2, 59.5, 59.1 |
| 62 | 58.4-59.6 | 60.9, 60.8, 60.2, 59.5, 59.1 |
| 134° F., | 57.8-58.5 | 57.7, 57.6, 57.5, 57.4, 57.3 |
| 50 minutes | | |

The data shows that pasteurizing the shell eggs in a 133° F. water bath even for 62 minutes, which is over the total time needed to achieve a 5 log kill of Salmonella Enteritidis in the yolk, affects albumen clarity significantly less than pasteurizing at 134° F. even at 50 minutes. These surprising results are apparent from viewing the photographs of the break out test (FIG. 5a through 5u, 6a though 6u, and 7). The break out appearance of the albumens of the eggs processed at 133° F. show very little, if any, visible cloudiness. In fact, the break out appearance of the albumens of the eggs processed at 133° F. as shown on the glass surface in FIGS. 6a through 6u are virtually clear to the human eye. On the other hand, the break out appearance of the albumens of the eggs processed at 134° F. as shown in FIG. 7 are more cloudy than the albumens in the eggs processed at 133° F. In addition, while the measured turbidity of the albumen of eggs pasteurized in a 134° F. water bath is well above 200 nephelometeric turbidity units, i.e., about 250 NTU; the measured turbidity of the albumen of eggs pasteurized in a 133° F. water bath is consistently below 200 nephelometeric turbidity units and the turbidity does not appear to increase on average as dwell times increase from 42 minutes to 62 minutes. In fact, there is no evidence that visible cloudiness or measured turbidity would increase if the shell eggs were held in a 133° F. water bath for longer than 62 minutes, although it would be more likely for the water bath temperature to temporarily rise to 134° F. or above which would likely cause cloudiness and turbidity.

The foregoing description of the invention is meant to be exemplary. It should be apparent to those skilled in the art that variations and modifications may be made yet implement various aspects or advantages of the invention. It is the object of the following claims to cover all such variations and modifications that come within the true spirit and scope of the invention.

1. A method of pasteurizing a chicken shell egg comprising the steps of:
i. heating one or more fluid pasteurization mediums to a desired set pasteurization temperature of no more than substantially about 133° F.;
ii. providing a pasteurization model predicting reductions of Salmonella Enteritidis in the yolk of chicken shell eggs;
iii. placing a chicken shell egg in said one or more fluid pasteurization mediums heated to the desired pasteurization temperature of no more than 133° F.;
iv. holding the chicken shell egg in said one or more fluid pasteurization mediums for a time sufficient to ensure that both the yolk and albumen of the egg have been pasteurized to achieve at least a statistical 5 log reduction of Salmonella Enteritidis at the set pasteurization temperature that may have been present in the yolk in its unpasteurized form according to said pasteurization model; and
v. removing the chicken shell egg from said one or more fluid pasteurization mediums;
wherein said egg has an albumen turbidity of less than 200 nephelometric turbidity units.

2. (canceled)

3. The method of claim 1 wherein the chicken shell egg is tempered to about 65° F. prior to being placed in the heated one or more fluid pasteurization mediums.

4. The method of claim 1 wherein the one or more fluid pasteurization mediums is heated water held in a pasteurization bath and heated with a heating system to heat the water to the desired set pasteurization temperature of no more than substantially about 133° F.

5. The method of claim 4 wherein the heated water in the pasteurization bath is cooled with a cooling system when the temperature exceeds the desired set pasteurization temperature and approaches an upper temperature limit of not more than about 0.5° F. to 1.0° F. above 133° F.

6. The method of claim 4 wherein the step of placing the egg in the water bath comprises enveloping at least one stack of a plurality of layers of eggs of a particular size in the water bath, said stack comprising layers of egg filled flats with at least thirty eggs in each flat.

7. The method of claim 5 further comprising supplying pressurized air into the heated water bath to perturbate the water across the surface of the eggs in the stack of eggs.

8. The method of claim 1 wherein the one or more fluid pasteurization mediums is heated humid air.

9. The method of claim 1 wherein the one or more fluid pasteurization mediums is the combination of heated water and heated humid air.

10. The method of claim 1 wherein the one or more fluid pasteurization mediums is heated convection air.

11. The method of claim 1 wherein the one or more fluid pasteurization mediums is the combination of heated convection air and another heated fluid pasteurization medium.

12. The method of claim 1 wherein the chicken shell egg is held in said one or more fluid pasteurization mediums for a predetermined time sufficient to ensure that both the yolk and albumen of the egg have been pasteurized to achieve at least a statistical 5 log reduction of Salmonella Enteritidis at the set pasteurization temperature that may have been present in the yolk in its unpasteurized form according to said pasteurization model.

13. The method of claim 1 further comprising the step of applying a coating over the entire surface of the shell of the chicken egg after the egg is removed from said one or more fluid pasteurization mediums.

14. A pasteurized chicken shell egg comprising:
a yolk having been pasteurized to achieve at least a statistical 5 log reduction of Salmonella Enteritidis that may have been present in the yolk in its unpasteurized form; and
an albumen having been pasteurized to achieve at least a statistical 5 log reduction of Salmonella Enteritidis that may have been present in the albumen in its unpasteurized form and having a measured turbidity of less than 200 nephelometric turbidity units.

15. The invention as recited in claim 14 wherein the pasteurized chicken shell egg is packaged together with multiple pasteurized chicken shell eggs in a carton or on a flat, and each of the multiple pasteurized chicken shell eggs meets the limitations of claim 14.

16. A shell egg pasteurization system comprising:
a pasteurization bath containing liquid water and having a series of at least two continuous zones;
at least one temperature sensor in each zone of the bath for measuring the water temperature in the zone of the bath;
a heating system that operates to increase the temperature of the water in each zone of the bath to a temperature set point value, said heating system including at least one independently controlled heating element in each zone of the bath;
a batch carrier arrangement that holds batches of shell eggs in the bath and includes an advance motor that moves the batch carrier arrangement and thereby the respective batches of shell eggs through and between zones;
an air bubble supply system that supplies pressurized air into the heated water bath to perturbate the water across the surface of eggs in the respective batches of shell eggs; and
a batch processing control system is programmed with at least one pasteurization protocol based on a pasteurization model predicting reduction of Salmonella Enteritidis in the yolk of chicken shell eggs, said protocol setting the temperature set point value for the water bath at no more than substantially about 133° F. and setting a total dwell time in the bath for each batch to a predetermined time sufficient to ensure that the yolk of the egg is pasteurized to achieve at least a statistical 5 log reduction of Salmonella Enteritidis that may have been present in the yolk in its unpasteurized form according to said pasteurization model;
wherein the temperature set point and the dwell in said pasteurization protocol are insufficient to cause the measured albumen turbidity of pasteurized eggs to exceed 200 nephelometric turbidity units.

17. (canceled)

18. The shell egg pasteurization system as recited in claim 16 further comprising a cooling system that operates to selectively lower the temperature of the water in the pasteurization bath when the temperature in one or more zones approaches an upper temperature limit that is set higher than the temperature set point value.

19. The shell egg pasteurization system as recited in claim 18 wherein the pasteurization protocol programmed into the batch processing system sets the upper temperature limit for the water in the bath higher than the temperature set point value, and the batch processing control system receives signals from the at least one temperature sensor in each zone of the bath and is configured to operate the heating system to independently raise the temperature of the water in each zone of the bath toward the temperature set point in response to signals from the at least one temperature sensor in each respective zone, is also configured to operate the cooling system to lower the temperature of the water in the bath in response to signals from at least one temperature sensor in the bath in order to maintain the temperature of the water below said upper temperature limit, and is further configured to control the advance motor of the batch carrier arrangement to move the batches of shell eggs through the series of zones in the bath and hold each batch of shell eggs in the water for said total dwell time.

20. The shell egg pasteurization system recited in claim 16 wherein each of the individually controlled heating elements comprises a heating coil located in one of the zones of the bath and an electronically controlled valve associated with the respective heating coil to control the flow of heated water through the respective heating coil, and the batch processing control system further comprises a programmable logic controller that is programmed with a proportional-integral-derivative algorithm for each of the individually controlled heating coils, each said proportional-integral-derivative algorithm using a temperature set point value defined by the pasteurization protocol and receiving a temperature feedback signal provided to the programmable logic controller from at least one temperature sensor associated with the respective heating coil, and wherein each of said proportional-integral-derivative algorithms generates a heating control signal that is transferred from the programmable logic controller to control operation of the electronically controlled valve associated with the respective heating coil.
